(19) United States
(12) Patent Application Publication
(10) Pub. No.: US 2026/0172644 A1
(43) Pub. Date: Jun. 18, 2026

(54) ELECTRONIC DEVICE, VIDEO MANAGEMENT METHOD, AND VIDEO EDITING DEVICE

(71) Applicant: Panasonic Intellectual Property Management Co., Ltd., Osaka (JP)

(72) Inventors: Shohei KANNO, Osaka (JP); Shohei KINUTA, Osaka (JP); Toshinari SUO, Osaka (JP)

(73) Assignee: Panasonic Intellectual Property Management Co., Ltd., Osaka (JP)

(21) Appl. No.: 19/412,993

(22) Filed: Dec. 9, 2025

(30) Foreign Application Priority Data
Dec. 17, 2024 (JP) 2024-220972

(51) Int. Cl. H04N 21/81; H04N 21/485

(52) U.S. Cl. CPC H04N 21/8113; H04N 21/4852

(57) ABSTRACT

An electronic device manages a video with a scenario including a plurality of sections, and includes: display that displays information; an input interface that inputs a user operation; and a controller that controls the display according to the user operation from the input interface. The controller causes the display to display a setting screen for audio source data associated with the scenario to acquire audio setting information associating a synchronous section in the plurality of sections with audio indicated by the audio source data, in accordance with the user operation. The controller generates, based on the acquired audio setting information, management data managing a positional relationship in which video information indicating respective videos in a plurality of videos associated with the plurality of sections to be arranged along a time series of the audio of the audio source data on an editing screen for editing the plurality of videos.

### TECHNICAL FIELD

The present disclosure relates to an electronic device, a video management method, and a video editing device for managing a video with a scenario including a plurality of sections such as cuts.

### BACKGROUND ART

JP 2013-012262 A discloses a synchronous reproduction device that displays a video of a dance performed in accordance with a music sound or the like in synchronization with a reproduced music sound. The synchronous reproduction device generates reproduction synchronization information for matching a synchronization relationship between reproduction timings of the video captured in synchronization with the music sound and the reproduced music sound based on music content corresponding to the music sound to a synchronization relationship between the music sound and the video at the time of imaging. The synchronous reproduction information is generated so as to include relative time information with respect to a reproduction start time of the music sound as a reference time, for each of reception times from an input means of start and end commands of the video data acquisition operation, start and end commands of the music sound reproduction or the synchronous reproduction.

In addition, JP 2013-012262 A discloses that the music content corresponding to music sound data is specified by analyzing music sound data, which is acquired by identifying the music sound and sound other than the music sound by analyzing sound collection data during a period in which video data is acquired from an imaging means. In this case, the synchronous reproduction device generates the reproduction synchronization information based on the specified music content instead of the above relative time information.

### SUMMARY

The present disclosure provides an electronic device, a video management method, and a video editing device capable of facilitating editing of a video shot with a scenario including a plurality of sections associated with audio source data.

In the present disclosure, an electronic device manages a video with a scenario including a plurality of sections. The electronic device includes a display that displays information, an input interface that inputs a user operation, and a controller that controls the display according to the user operation input from the input interface. The controller causes the display to display a setting screen for audio source data associated with the scenario to acquire audio setting information in accordance with the user operation from the input interface, the audio setting information associating a synchronous section in the plurality of sections with audio indicated by the audio source data. The controller generates management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos, the video information indicating respective videos in the plurality of videos.

In the present disclosure, a video management method is a method for managing a video with a scenario including a plurality of sections. In the present method, a controller of an electronic device causes a display to display a setting screen for audio source data associated with the scenario to acquire audio setting information in accordance with a user operation input from an input interface, the audio setting information associating a section in the plurality of sections with audio indicated by the audio source data. The controller generates management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos, the video information indicating respective videos in the plurality of videos.

In the present disclosure, a video editing device includes: a display that displays an editing screen for editing a plurality of videos; a data input interface that inputs data; an user interface that receives a user operation; and a controller that controls the display based on the data input from the data input interface. The controller acquires, from the data input interface, video data indicating a video, audio source data associated with a scenario including a plurality of sections, and management data, the video being shot in association with each section in the scenario, the management data associating a synchronous section in the plurality of sections with audio indicated by the audio source data. The management data manages a positional relationship in which video information is to be arranged on the editing screen along a time series of the audio of the audio source data, the video information indicating respective videos associated with the plurality of sections. The controller causes the display to display a timeline in which the video information of the synchronous section associated with the audio among the plurality of sections is arranged on the editing screen along the time series of the audio source data based on the management data, and receives the user operation editing a video indicated by the video information from the user interface on the editing screen.

According to the electronic device, the video management method, and the video editing device of the present disclosure, it is possible to facilitate editing of a video shot with a scenario including a plurality of sections associated with audio source data.

### BRIEF DESCRIPTION OF DRAWINGS

FIG. 1 is a diagram illustrating a configuration of an imaging system according to a first embodiment of the present disclosure;

FIG. 2 is a diagram illustrating a configuration of a digital camera in the imaging system;

FIG. 3 is a diagram illustrating a configuration of an information support terminal in the imaging system;

FIG. 4 is a diagram illustrating a display example of a function selection screen in the information support terminal;

FIG. 5 is a flowchart illustrating an operation of a scenario creation function in the imaging system;

FIG. 6 is a diagram illustrating a display example of a scenario input screen in the information support terminal;

FIG. 7 is a diagram illustrating a display example in setting of a music range by the scenario creation function;

FIG. 8 is a diagram illustrating a data structure of cut allocation data in the information support terminal;

FIG. 9 is a diagram illustrating a display example of a cut selection screen in the information support terminal;

FIG. 10 is a flowchart illustrating an operation of a cut shooting function in the imaging system;

FIG. 11 is a diagram illustrating a display example of a rating screen in the information support terminal;

FIG. 12 is a flowchart illustrating recording mode processing in the imaging system;

FIGS. 13A to 13D are diagrams each illustrating a display example in the recording mode of the information support terminal;

FIGS. 14A to 14C are diagrams for explaining a synchronous playback function in the recording mode of the information support terminal;

FIG. 15 is a diagram illustrating a data structure of video metadata in the information support terminal;

FIG. 16 is a diagram illustrating a display example of a video edit screen in a video editing PC of the imaging system;

FIG. 17 is a flowchart illustrating an operation of an export function in the imaging system;

FIG. 18 is a diagram illustrating a video timeline for a lip synch on the video edit screen;

FIG. 19 is a diagram illustrating a video timeline for a B-roll on the video editing screen;

FIG. 20 is a flowchart illustrating timeline setting processing in the imaging system;

FIG. 21 is a diagram illustrating a data structure of management data according to the timeline setting processing;

FIG. 22 is a flowchart illustrating an operation of the video editing PC in the imaging system; and

FIG. 23 is a diagram for explaining the operation of the video editing PC.

### DETAILED DESCRIPTION

Embodiments will be described in detail below with reference to the drawings as appropriate. However, detailed description of already well-known matters and redundant description of substantially the same configuration may be omitted. Note that the accompanying drawings and the following description are provided for those skilled in the art to fully understand the present disclosure, and are not intended to limit the subject matter described in the claims.

### First Embodiment

In a first embodiment of the present disclosure, a system using an electronic device separate from an imaging apparatus that executes video shooting will be described.

### 1. Configuration

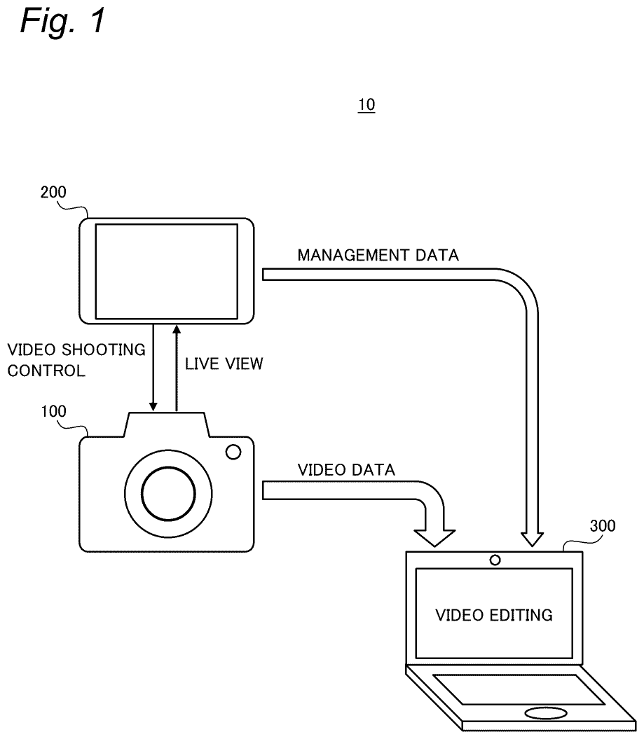

An imaging system according to the first embodiment of the present disclosure will be described with reference to FIG. 1.

For example, as illustrated in FIG. 1, a system 10 includes a digital camera 100, an information support terminal 200, and a video editing personal computer (PC) 300. In the present system 10, the digital camera 100 and the information support terminal 200 are data-communicably connected by, for example, wired communication or wireless communication.

The present system 10 is applicable to an application in which a user creates a desired video work such as a music video or a dance video by shooting and editing a plurality of videos with the digital camera 100, for example. For example, the present system 10 provides information support useful for a series of workflows in which the user creates a scenario indicating a concept of the video work associated with the music, repeats video shooting according to a plurality of cuts set in the scenario, and edits a plurality of captured videos. In the present system 10, the cuts are set as shooting sections that divide the scenario.

In the present system 10, the information support terminal 200 can manage, for example, a scenario of a video work, and control the digital camera 100 so as to manage video shooting for each cut. For example, a live view image in the digital camera 100 can be confirmed on the information support terminal 200. Video data of shooting results of by digital camera 100 is edited in the video editing PC 300. The present system 10 uses data managed by the information support terminal 200 from the viewpoint of facilitating video editing in the video editing PC 300 and the like.

In the present system 10, the video editing PC 300 may or may not be communicably connected to one or both of the digital camera 100 and the information support terminal 200. For example, data from the digital camera 100 and/or the information support terminal 200 may be input to the video editing PC 300 via a portable recording medium such as a memory card. The present system 10 may not include the video editing PC 300.

### 1.1. Configuration of Digital Camera

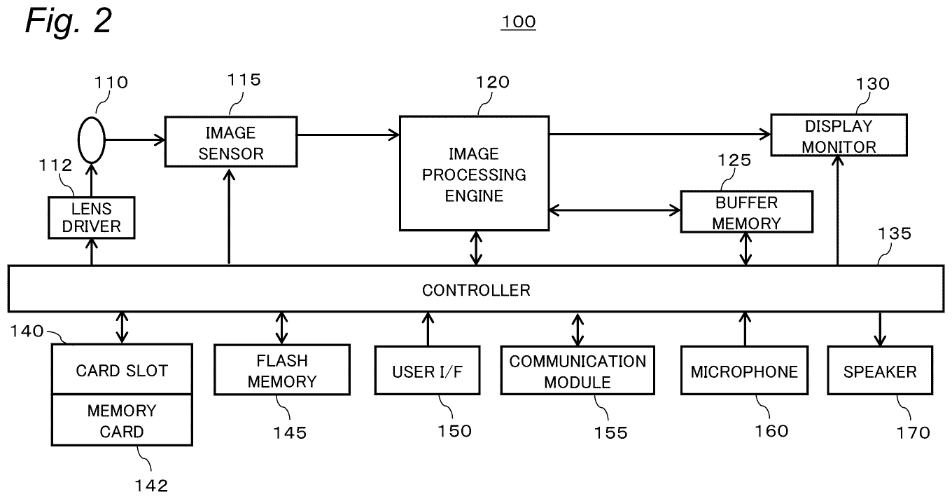

A configuration of the digital camera 100 in the present embodiment will be described with reference to FIG. 2.

FIG. 2 is a diagram illustrating the configuration of the digital camera 100 in the present system 10. The digital camera 100 is an example of an imaging apparatus in the present embodiment. The digital camera 100 according to the present embodiment includes an image sensor 115, an image processing engine 120, a display monitor 130, and a controller 135. Further, the digital camera 100 includes a buffer memory 125, a card slot 140, a flash memory 145, a user interface 150, a communication module 155, a microphone 160, and a speaker 170. Furthermore, the digital camera 100 includes an optical system 110 and a lens driver 112, for example.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like includes one lens or more lenses.

The lens driver 112 drives the focus lens and the like in the optical system 110. The lens driver 112 includes a motor, to move the focus lens along the optical axis of the optical system 110 under the control of the controller 135. The configuration for driving the focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 executes an operation of capturing a still image, an operation of capturing a through image, and the like. The through image is mainly a video, and is displayed on the display monitor 130 for the user to determine a composition for capturing a still image. Each of the through image and the still image is an example of a captured image in the present embodiment. The image sensor 115 is an example of an imager in the present embodiment.

The image processing engine 120 performs various processing on the imaging data output from the image sensor 115 to generate image data, and performs various types of processing on the image data to generate an image to be displayed on the display monitor 130. Examples of various types of processing include white balance correction, gamma correction, YC conversion processing, electronic zoom processing, compression processing, expansion processing, and the like, but the various processing are not limited thereto. The image processing engine 120 may be configured by a hard-wired electronic circuit, or may be configured by a microcomputer using a program, a processor, or the like.

The display monitor 130 is an example of a display that displays various information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be configured by, for example, a liquid crystal display device or an organic EL device.

The user interface 150 is a general term for hard keys such as operation buttons and operation levers provided on the exterior of the digital camera 100, and is operable to receive an operation by the user. For example, the user interface 150 includes a release button, a mode dial, and a touch panel. When the user interface 150 receives an operation by the user, the user interface 150 transmits an operation signal corresponding to the user operation to the controller 135.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Although not illustrated, the controller 135 may include various internal memories, and may incorporate a ROM, for example. The ROM stores various programs to be executed by the controller 135. The controller 135 may include a RAM built therein that functions as a work area of the CPU.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155.

The microphone 160 includes, for example, one or more microphone elements built in the digital camera 100. The microphone 160 outputs a sound signal indicating the collected sound to the controller 135. An external microphone may be used in the digital camera 100. The digital camera 100 may include a connector such as a terminal connected to an external microphone instead of or in addition to the built-in microphone 160.

The speaker 170 includes, for example, one or more speaker elements built in the digital camera 100 and outputs sound to the outside of the digital camera 100 by performing audio output under the control of the controller 135. In the digital camera 100, an external speaker, an earphone, or the like may be used. The digital camera 100 may include a connector connected to an external speaker or the like instead of or in addition to the built-in speaker 170.

### 1.2. Configuration of Information Support Terminal

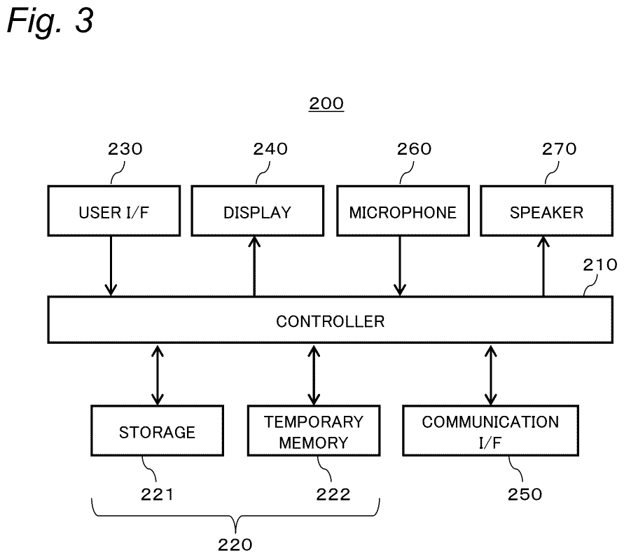

A configuration of the information support terminal 200 in the present embodiment will be described with reference to FIG. 3.

FIG. 3 is a diagram illustrating the configuration of the information support terminal 200. The information support terminal 200 is an example of an electronic device including, for example, a smartphone, a tablet terminal, a PC, or the like. The information support terminal 200 illustrated in FIG. 3 includes a controller 210, a memory 220, a user interface 230, a display 240, a communication interface 250, a microphone 260, and a speaker 270.

The controller 210 includes a CPU or an MPU that realizes a predetermined function in cooperation with software, for example. The controller 210 controls the overall operation of the information support terminal 200, for example. The controller 210 reads data and programs stored in the memory 220 and performs various calculation processing to realize various functions.

For example, the controller 210 executes a program including a command group for realizing each of the above-described functions. The above program may be provided from a communication network such as the Internet, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a memory medium that stores programs and data necessary for implementing the functions of the information support terminal 200. As illustrated in FIG. 3, the memory 220 includes a storage 221 and a temporary memory 222.

The storage 221 stores parameters, data, control programs, and the like for realizing a predetermined function. The storage 221 includes, for example, an HDD or an SSD. For example, the storage 221 stores the above-described program, various image data, audio source data indicating audio of the music to be played in a video work, and the like.

The temporary memory 222 includes a RAM such as a DRAM or an SRAM, to temporarily store (i.e., hold) data, for example. For example, the temporary memory 222 holds image data in the middle of being edited. In addition, the temporary memory 222 may function as a work area of the controller 210, and may be configured by a storage area in an internal memory of the controller 210.

The user interface 230 is a general term for operation members operated by a user. The user interface 230 is, for example, a touch panel superimposed on the display 240 to input various touch operations, and is an example of an input interface of the information support terminal 200. The input interface may be a connection software unit that is communicably connected to various external input devices and receives an operation signal. The user interface 230 may be a physical button, a switch, or the like provided in the information support terminal 200, or a keyboard, a mouse, a touch pad, or the like may be used. The user interface 230 may be various GUIs such as virtual buttons and icons, cursors, software keyboards, and objects displayed on the display 240.

The display 240 includes, for example, a liquid crystal display or an organic EL display. The display 240 may display various information such as various GUIs for operating the user interface 230 and information input from the user interface 230.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the information support terminal 200 to a communication network such as the Internet. The communication interface 250 is an example of an acquisition unit that receives various types of information from an external device or a communication network. The communication interface 250 may constitute a data input interface that inputs various data to the information support terminal 200.

The microphone 260 includes, for example, one or more microphone elements built in the information support terminal 200. The microphone 260 outputs a sound signal indicating the collected sound to the controller 210. The information support terminal 200 may include a connector such as a terminal connected to an external microphone instead of or in addition to the built-in microphone 260.

The speaker 270 includes, for example, one or more speaker elements built in the digital camera 100, and outputs a sound to the outside of the information support terminal 200 by performing audio output under the control of the controller 210. The information support terminal 200 may include a connector connected to an external speaker, an earphone, or the like instead of or in addition to the built-in speaker 270.

The configuration of the information support terminal 200 as described above is an example, and the configuration of the information support terminal 200 is not limited thereto. For example, various display devices such as a projector and a head mounted display may be used as the display 240 of the information support terminal 200. For example, in a case where an external display device is used, the display 240 of the information support terminal 200 may be, for example, an output interface circuit of a video signal or the like conforming to the HDMI standard or the like.

### 1.3. Configuration of Video Editing PC

The video editing PC 300 in the present system 10 is configured as a PC as an example of an information processing apparatus. The video editing PC 300 is an example of the video editing device in the present embodiment. The video editing PC 300 of the present system 10 has a configuration similar to that of the information support terminal 200 illustrated in FIG. 3, for example. The video editing PC 300 may not include a built-in microphone. Furthermore, the video editing PC 300 may include a connector connected to an external speaker or the like and an output interface circuit of a video signal or the like instead of or in addition to the built-in speaker and display.

### 2. Operation

The operation of the present system 10 configured as described above will be described below.

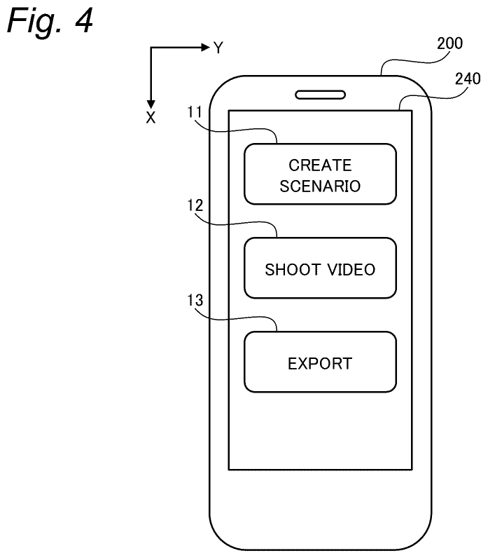

In the present system 10, the information support terminal 200 has various functions for sequentially providing information support to the user in the workflow of video production. A display example of a screen for selecting various functions of the information support terminal 200 is illustrated in FIG. 4.

The display 240 of the information support terminal 200 displays a scenario creation button 11, a video shooting button 12, and an export button 13 on the function selection screen illustrated in FIG. 4. Hereinafter, the longitudinal direction on the screen of the display 240 is defined as an X direction, and the width direction is defined as a Y direction.

The scenario creation button 11 is a virtual button that receives a user operation for executing a function of performing information support for a process of creating a scenario by the user (i.e., a scenario creation function) before shooting a video in the present system 10. The information support terminal 200 of the present system 10 manages various types of information on each cut for managing video shooting with the scenario created in this way. The cut constitutes a section in a plurality of times of video shooting for a scenario, for example.

The video shooting button 12 is, for example, a virtual button for executing a function (i.e., a cut shooting function) of supporting video shooting of each cut in a scenario created by the scenario creation function. The number of times of shooting a video for one cut is not particularly limited to one take, and may be a plurality of takes. In the present embodiment, the information support terminal 200 controls video shooting by the digital camera 100 in the cut shooting function, and manages an shooting result for each cut.

The export button 13 is a virtual button for executing a function (i.e., an export function) of performing pre-processing for external output on a management result of video shooting by the cut shooting function and outputting the result. The pre-processing by the export function provides information support for facilitating a process of editing a video of a plurality of shooting results according to a scenario in the video editing PC 300, for example.

The information support terminal 200 of the present system 10 can provide comprehensive information support from creation of a scenario to pre-processing of video editing, for example, when the user sequentially uses the functions of the scenario creation button 11, the video shooting button 12, and the export button 13.

For example, a video work such as a dance video or a music video to be played associating video data with audio source data such as audio data of a music track, is produced by video editing after shooting a plurality of videos as materials. In such video editing, a process of manually synchronizing the respective video materials with a time range in the music of the music track or the like indicated by the audio source data is complicated, and conventional automation technologies have problems in inaccurate synchronization and excessive load on editing. Therefore, the present system 10 manages the time range in the audio source data according to a user's intention for each cut set in the scenario, by utilizing information acquired from user operations in the scenario creation function.

By the export function of the information support terminal 200, the present system 10 can output, to the video editing PC 300, management data in which the time range in the audio source and the like for each cut as described above are managed. In this way, the video editing PC 300 can easily achieve a state in which a video of the shooting result for each cut is synchronized with the audio source data, as intended by the user creating the scenario, when reading the video into the editing software or the like based on the management data output in the present system 10. With the present system 10, in video editing to synchronize a video material with the audio source data, arrangement of the video material in accordance with the user's intention is prepared from beginning of editing work, and this facilitates desired editing by the user and can reduce the load on editing, for example.

### 2.1. Scenario Creation Function

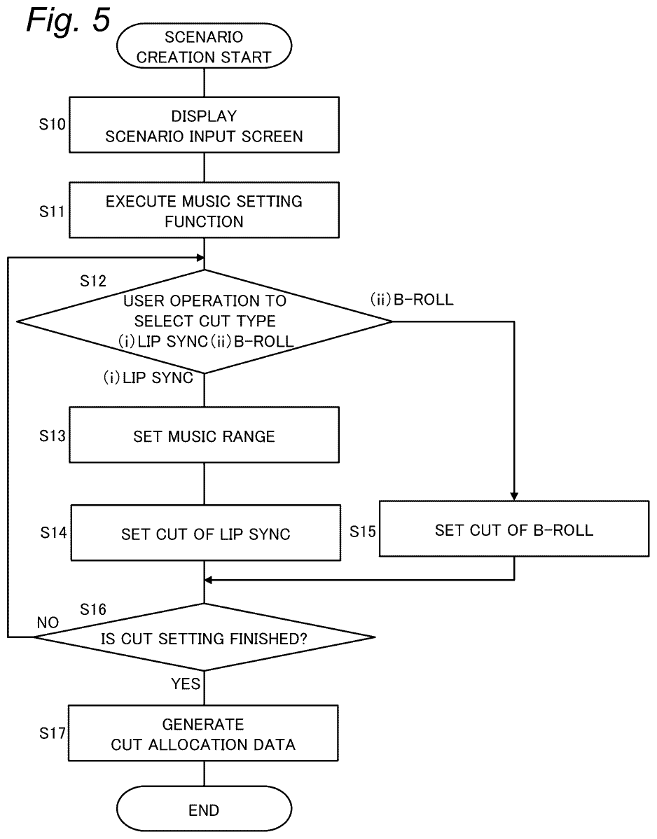

The scenario creation function in the information support terminal 200 of the present system 10 will be described with reference to FIGS. 5 to 8.

FIG. 5 is a flowchart illustrating an operation of the scenario creation function in the imaging system 10. Each processing illustrated in this flowchart is executed by the controller 210 of the information support terminal 200, for example. The processing of this flowchart is started in response to the user operation of the scenario creation button 11 on the function selection screen of FIG. 4, for example.

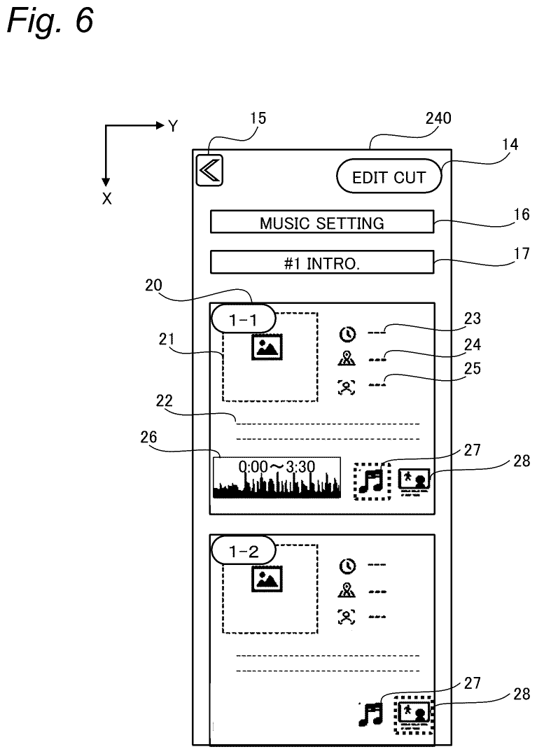

When the user operation such as tapping the scenario creation button 11 on the function selection screen of FIG. 4 is input from the user interface 230, the controller 210 causes the display 240 to display the scenario input screen illustrated in FIG. 6 (S10). FIG. 6 illustrates a display example of the scenario input screen in the information support terminal 200.

The scenario input screen is a screen for the user to input a scenario to the information support terminal 200 in the scenario creation function of the present system 10. For example, as illustrated in FIG. 6, the scenario input screen includes a storyboard input field 20 for each cut, a cut edit button 14, a return button 15, a music setting button 16, and a scene setting button 17. The controller 210 of the information support terminal 200 causes the user interface 230 to receive various user operations related to the scenario input screen displayed on the display 240 (S11 to S15).

In the information support terminal 200, the storyboard input field 20 receives a user input of information indicating a storyboard such as an outline of a scenario concept for each cut constituting a scenario. As illustrated in FIG. 6, for example, the storyboard input field 20 for each cut includes a composition field 21, a script field 22, a shooting duration field 23, a shooting location field 24, and a memo field 25. The storyboard input field 20 further includes a lip synch icon 27 and a B-roll icon 28 regarding synchronization between the video and the audio of the music for each cut.

The composition field 21 receives an input of image information indicating a composition or the like in the video shooting of the cut. The input of the image information may be drawing by user operation or designation of image data. The script field 22 receives a text input such as a script divided for the cut in the scenario.

The shooting duration field 23 receives a numerical value input indicating a rough time length for shooting the video of the cut. The shooting duration field 24 receives an input of information indicating a location where the video of the cut is captured. The input of the shooting duration may be text input, or data search or the like may be appropriately used. The memo field 25 receives inputs of various types of information desired by the user, such as imaging equipment and/or zooming of the subject, with respect to the video shooting of the cut, for example, by text input.

Each of the lip synch icon 27 and the B-roll icon 28 indicates a type of cut, and receives a user operation of selecting one for each cut. The lip synch icon 27 indicates the cut of “lip synch” that synchronizes audio of the music with a video image in the video such that performance of the music or dance according to the music is shot, for example. The B-roll icon 28 indicates the cut of “B-roll” in which the audio of the music is not synchronized with the video image in the video such that narration or a scenery is shot, for example. The information support terminal 200 further displays a music editing field 26 in the storyboard input field 20 for the cut for which the lip synch icon 27 is selected. The music editing field 26 receives a user input of information indicating the time range in the music, as a music range, to be associated with the video so that the music range is synchronized with the video image in the cut of the lip synch.

In the example of FIG. 6, the display 240 displays storyboard input fields 20 for two cuts. The controller 210 acquires the storyboard information for each cut according to the user input to the various fields 21 to 25 in the storyboard input field 20 for each cut in the scenario. The controller 210 further acquires the storyboard information by a user input to the music editing field 26 according to a user operation of selecting each of the icons 27 and 28. On the scenario input screen of the information support terminal 200, the storyboard input field 20 of the cut displayed on the display 240 can be changed according to, for example, a swipe operation for scrolling in the X direction in which the storyboard input field 20 for each cut is arranged.

The cut edit button 14 switches on/off a state in which various user operations such as addition, deletion, and order change of cuts included in the scenario can be input. For example, by a touch operation in the on state of the cut edit button 14, the user can arrange the storyboard input fields 20 for a desired number of cuts in order in time series in the scenario.

The return button 15 receives a user operation of returning the screen transition in the information support terminal 200 by one screen. For example, the controller 210 causes the display 240 to transition to the function selection screen (FIG. 4) in response to the user operation of the return button 15 on the scenario input screen (FIG. 6).

The music setting button 16 is a virtual button for setting music to be played in a video work in the scenario. The controller 210 of the information support terminal 200 executes various functions related to music setting in response to a user operation of the music setting button 16 (S11).

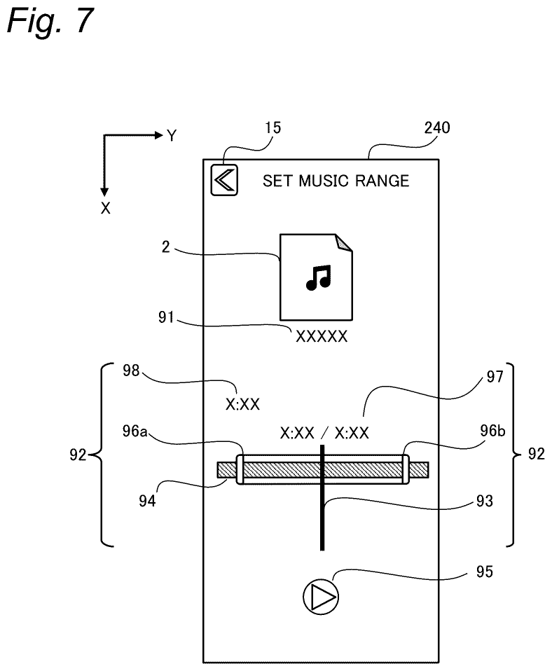

For example, the controller 210 causes the display 240 to display a title of the music or the like as an option based on data stored in the storage 221 or the like so as to receive a user operation of selecting the music by the user interface 230 (S11). After selecting the music, the controller 210 receives a user input of information indicating a range to be included in the video work among a period in which the audio can be played back based on the audio source data of the music, the range being specified by, a display similar to the setting of the music range for the cut of lip synch to be described later (see FIG. 7), for example (S11).

The scene setting button 17 is a virtual button for setting a shooting scene for one or more cuts in the scenario. The scene setting button 17 receives, for example, information indicating the shooting scene according to a structure of the music, a shooting site, or the like by text input.

In the operation of the scenario creation function illustrated in FIG. 5, for example, after execution of the function of setting the music to the scenario (S11), the controller 210 sets each cut according to the user input to the content input field 20 for each cut on the scenario input screen (FIG. 6) (S12 to S15).

For example, the controller 210 receives, via the user interface 230, a user operation of selecting the type of cut with the lip synch icon 27 or the B-roll icon 28 in the storyboard input field 20 for each cut (S12).

When a user operation of selecting the lip synch icon 27 is input ((i) in S12), the controller 210 sets the music range to be associated with the cut selected by the lip synch icon 27 (S13). For example, the controller 210 causes the music editing field 26 to be displayed in the storyboard input field 20 of the cut, and causes the display 240 to display a screen for setting the music range in response to a user operation such as tapping the music editing field 26. FIG. 7 is a diagram illustrating a display example in the setting of the music range by the scenario creation function.

For example, the screen illustrated in FIG. 7 includes a music icon 2 indicating a file in which the audio source data of the music is stored, a music name 91 indicating the title of the music or a file name of the corresponding audio source data, a playback field 92, a playback button 95, and a return button 15. For example, the title of the music selected in step S11 is displayed as the music name 91. The playback button 95 receives a user operation for starting or stopping audio output by the speaker 270 or the like.

The playback field 92 receives a user operation for specifying a range in the sound of the music. As illustrated in FIG. 7, for example, the playback field 92 includes a playback head 93, an audio timeline 94, markers 96a and 96b, a period display 97, and a marker time 98.

The playback head 93 is arranged on the audio timeline 94, for example, and indicates a position corresponding to a time in playing the audio source data of the music indicated by the music name 91. For example, the audio timeline 94 is sequentially updated according to the playback of the music so as to display, from the position indicated by the playback head 93 in the period of the audio source data, a time range already played in the −Y direction and a time range to be played in the +Y direction. The audio timeline 94 may display a part of the period, such as a predetermined period around (i.e., before and after) the position of the playback head 93 in the audio source data. For example, the predetermined period displayed in the audio timeline 94 may be changed by a user operation of pinching the audio timeline 94 in or out.

Furthermore, the playback head 93 may be fixed to the center in the Y direction in the audio timeline 94, and for example, a time of the playback head may be changed by a user operation of scrolling the audio timeline 94 in the +Y direction or −Y direction.

The marker 96a and the marker 96b indicate a start point and an end point of the time range designated from the audio of the music, respectively, and move in the Y direction on the audio timeline 94 according to a drag operation or the like of each marker 96. The period display 97 displays one or more periods in the audio of the music. For example, the period display 97 illustrated in FIG. 7 displays a period from the start point to the end point designated by the marker 96 with an entire period in the music used for an entire video work in the scenario set in step S11.

The marker time 98 indicates a time of a start point or an end point designated by the marker 96a or 96b being operated with respect to a start time of the entire period in the period display 97, for example. The controller 210 acquires information indicating the time range designated by each marker 96, and sets the music range to be associated with the cut of the lip synch from the time range in the music based on the acquired information (S13). For the cut of the lip synch, the entire period set in the scenario may be associated as a default range before the music range is specified by the marker 96.

The controller 210 sets the cut of the lip synch in association with the music range set in step S13 (S14). For example, the controller 210 sets the cut based on the storyboard information acquired in accordance with the user input to the various fields 21 to 25 of the storyboard input field 20, in addition to the type of cut and the music range. In the scenario input screen illustrated in FIG. 6, the first cut of displayed two cuts is set as the cut of the lip synch. The controller 210 displays a waveform representing the audio source data of the music and a numerical value indicating the music range set to the cut in the music editing field 26, for example.

On the other hand, when a user operation of selecting the B-roll icon 28 is input in the storyboard input field 20 for each cut ((ii) in S12), the controller 210 sets the cut of the B-roll in accordance with user inputs to the various fields 21 to 25 in addition to the type of cut (S15). In the example of FIG. 6, the second cut is set as the cut of the B-roll.

The controller 210 determines whether or not the setting of the cut is finished according to whether or not a user operation of the return button 15 is input on the scenario input screen, for example (S16).

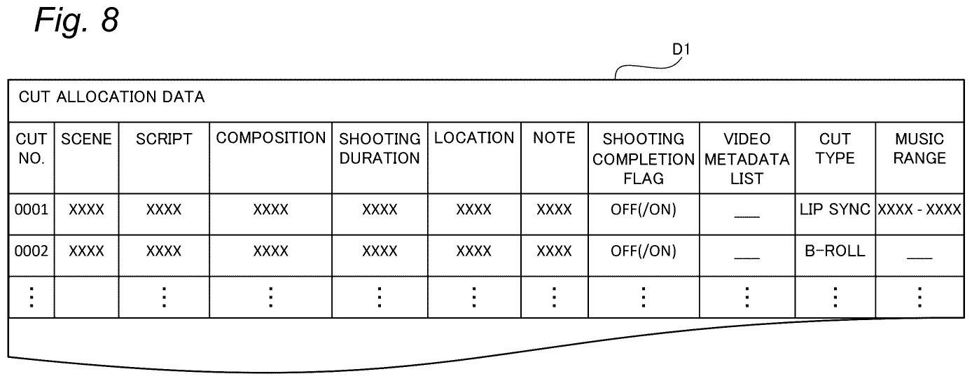

When the setting of the cut is finished (YES in S16), the controller 210 generates cut allocation data including storyboard information of each cut as an output of the scenario creation function, and stores the cut allocation data in the storage 221 (S17). The cut allocation data at the end of such a scenario creation function is illustrated in FIG. 8.

For example, as illustrated in FIG. 8, cut allocation data D1 manages “scene”, “script”, “composition”, “shooting duration”, “location”, “note”, “shooting completion flag”, “video metadata list”, “cut type”, and “music range” in association with each other for each “cut number”. The cut allocation data D1 is an example of management information in the present embodiment.

For example, the controller 210 of the information support terminal 200 assigns cut numbers indicating cut identification information in the cut allocation data D1 in ascending order in the storyboard input field 20 for each cut arranged on the scenario input screen. When the cut order is changed, the controller 210 re-assigns the cut numbers according to the changed order. Further, the controller 210 records the information input by the scene setting button 17 on the scenario input screen for one or more cuts in the “scene” of the corresponding cut in the cut allocation data D1.

For each cut, the controller 210 records each piece of information input to the script field 22, the composition field 21, the shooting duration field 23, the shooting location field 24, and the note field 25 of the storyboard input field 20 in “script”, “composition”, “shooting duration”, “location”, and “note” of the cut allocation data D1, respectively.

In the cut allocation data D1, the “shooting completion flag” manages whether the cut is in a state of shooting completion or in a state of imaging incompletion by ON/OFF. At the end of the scenario creation function, the shooting completion flag is set to OFF for all cuts as an initial setting.

The “video metadata list” is a list for storing metadata of a video captured in association with the cut. At the end of the scenario creation function, the video metadata list is set to an empty value as an initial setting.

The “cut type” manages the type of cut set to the cut. The type of cut is selected from, for example, the lip synch and the B-roll according to the user operation in step S12, and the selected type is set to the cut in steps S14 and S15.

The “music range” manages the time range in the music set to the cut in steps S13 and S14 for the cut whose cut type is the lip synch. In this example, the music range is set to an empty value for the cut whose cut type is the B-roll. The cut allocation data D1 may include information indicating a time range of the music associated with the whole video work, the information being input in step S11, or the information may be managed separately from the cut allocation data D1 in the storage 221.

After generating the cut allocation data D1 (S17), the controller 210 ends the processing of this flowchart.

As described above, according to the scenario creation function in the information support terminal 200 of the present system 10, by generating the cut allocation data D1 from the user input on the scenario input screen (S11 to S17), information support of the process of creating the scenario of the video work desired by the user for each cut can be performed. For example, the cut of the lip synch or the B-roll can be set in accordance with whether or not to synchronize the audio of the music set in the scenario and the video image (S11 to S15). Further, the cut of the lip synch can be set in association with music range desired by the user (S13,S14). For example, a common range may be associated with multiple cuts of the lip synch.

The scenario creation function of the information support terminal 200 is not particularly limited to the above. For example, the information support terminal 200 may receive a user instruction for outputting data of the storyboard information of the scenario input on the scenario input screen using a data format (e.g., PDF format) that can be shared by another device, and perform the data output.

### 2.2. Cut Shooting Function

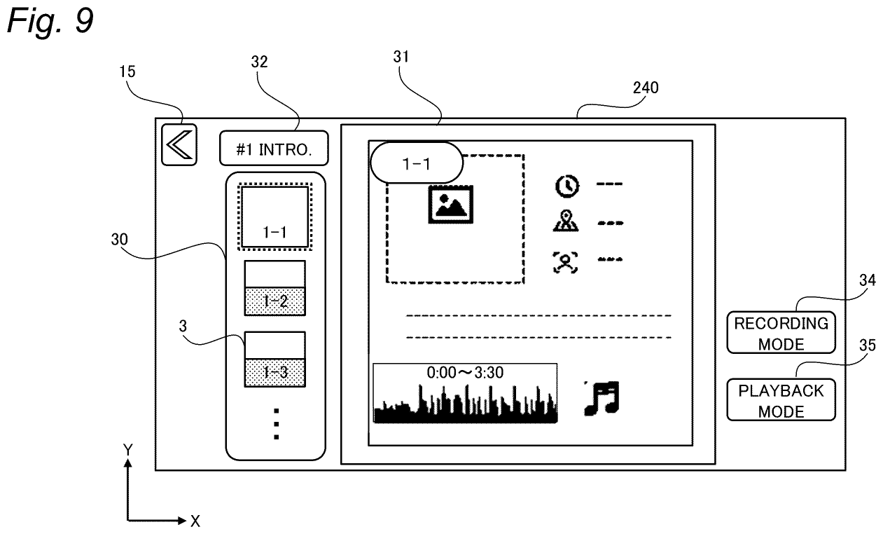

An outline of an operation of the cut shooting function in the information support terminal 200 of the present system 10 will be described with reference to FIG. 9.

FIG. 9 illustrates a display example of a cut selection screen on the information support terminal 200. The cut selection screen is a screen for selecting a cut desired by the user from cuts provided in, for example, the scenario creation function in the cut shooting function of the present system 10. The cut selection screen is an example of a selection screen in the information support terminal 200 according to the present embodiment.

As illustrated in FIG. 9, for example, the cut selection screen includes a cut list 30, a storyboard display field 31, a filter button 32, a recording mode button 34, a playback mode button 35, and a return button 15. The cut list 30 is a list listing various cuts as options selectable by the user. The storyboard display field 31 is a display field for displaying storyboard information on the selected cut. Details of the cut selection screen will be described later.

In the cut shooting function of the present system 10, the information support terminal 200 provides information support that facilitates for the user to comprehensively carry out video shooting of each cut with checking various cuts, by using the cut selection screen illustrated in FIG. 9, for example. The user may perform video shooting in an order different from the cut order in the scenario, or may perform video shooting of a plurality of takes for video shooting of one cut.

Therefore, the information support terminal 200 of the present system 10 receives the rating by the user of the video for the selected cut at shooting the video of each take, manages whether or not the shooting of the cut is completed, and visualizes the progress status of the video shooting for each cut in the cut list 30 for the user. Details of the operation of the present system 10 will be described below.

### 2.2.1. Overall Operation of Cut Shooting Function

The overall operation of the cut shooting function in the present system 10 will be described with reference to FIGS. 9 to 11.

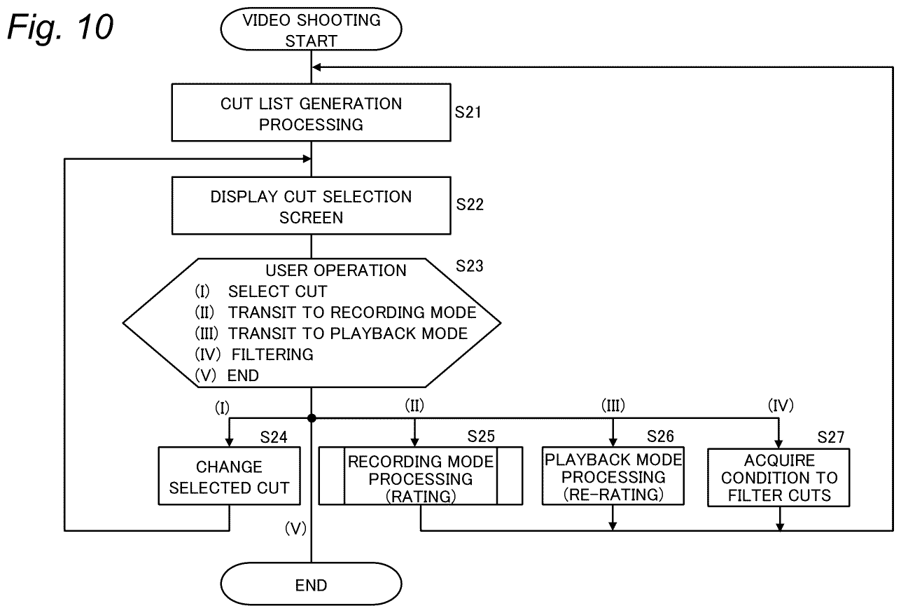

FIG. 10 is a flowchart illustrating an operation of the cut shooting function in the present system 10. Each processing of the flowchart of FIG. 10 is executed by the controller 210 of the information support terminal 200, for example. The processing of this flowchart is started, for example, when the video shooting button 12 on the function selection screen (FIG. 4) is operated in a state where the cut allocation data D1 by the scenario creation function is stored in the memory 220 and the communication connection with the digital camera 100 is established in the communication interface 250.

First, the controller 210 of the information support terminal 200 generates the cut list 30 to be displayed on the cut selection screen (FIG. 9) based on the cut allocation data D1 (S21). For example, the cut list generation processing (S21) is repeatedly executed in the present system 10 in accordance with the progress status of video shooting and various operations of the user during execution of the cut shooting function, and sequentially updates the cut list 30.

Next, the controller 210 causes the display 240 to display a cut selection screen based on the generated cut list 30 and the cut allocation data D1 as illustrated in FIG. 9, for example (S22).

As illustrated in FIG. 9, for example, the cut list 30 on the cut selection screen includes a plurality of cut icons 3. Each cut icon 3 indicates an individual cut as an option. The cut icon 3 being selected is set to the cut number “1” in an initial state, for example.

For example, the controller 210 controls the display 240 to highlight the cut icon 3 indicating the selected cut (S22). The highlighted display of the selected cut icon 3 is a larger display size than that of the other cut icons 3, a frame enclosure of a highlight color, and the like, for example. Further, referring to the cut allocation data D1, the controller 210 causes the storyboard display field 31 to display the storyboard information about the cut indicated by the selected cut icon 3 (S22).

In the example of FIG. 9, the cut with the cut number “1” is in a state where video shooting is not completed, and the cut with the cut numbers “2” and “3” is in a state where video shooting is completed. In the cut list 30 according to the present embodiment, the cut icon 3 has a display attribute for identifying a complete state and an incomplete state of video shooting. Such a display attribute is set, for example, so as to highlight the display mode in which the display mode of the shooting completion state is the imaging incomplete state.

The controller 210 receives various user operations with the user interface 230 such as a touch panel while the display 240 displays the cut selection screen as illustrated in FIG. 9, for example (S23). The target user operation in step S23 includes (I) a cut selection operation, (II) a transition operation to the recording mode, (III) a transition operation to the playback mode, (IV) a filtering operation, and (V) an end operation.

The cut selection operation ((I) in S23) is a user operation of changing the selected cut, and is an operation of tapping the cut icon 3 other than the selected cut icon 3 in the cut list 30 displayed on the cut selection screen, for example. The cut selection operation is not limited thereto, and a swipe operation in the storyboard display field 31 may be input as a cut selection operation of changing the selected cut to an adjacent cut, for example.

When the cut selection operation is input ((I) in S23), the controller 210 changes the selected cut icon 3 according to the input cut selection operation (S24), and performs the processing in and after step S2 again. As a result, on the cut selection screen, the selected cut icon 3 is changed, and the storyboard display field 31 is displayed for a new selected cut (S22).

The transition operation to the recording mode ((II) in S23) is a user operation for shifting to the recording mode, which is an operation mode for shooting a video related to the selected cut, and is, for example, a tap operation on the recording mode button 34. Additionally or alternatively, the transition operation may be a swipe operation in a predetermined one of the +X direction and −X direction of the cut selection screen. Furthermore, the recording mode button 34 may be omitted.

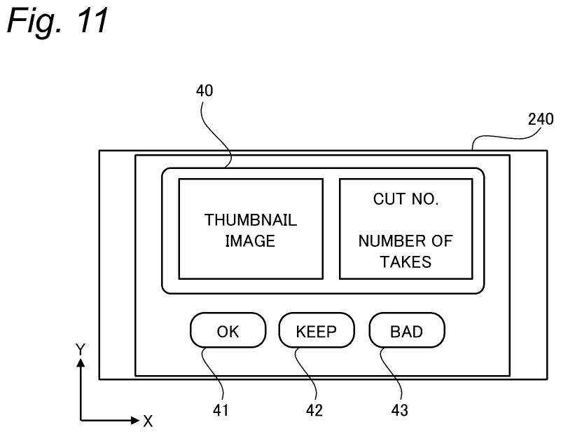

When the transition operation to the recording mode is input ((II) in S23), the controller 210 executes, as the recording mode, various types of processing for shooting a video of one take in association with the selected cut (S25). A display example in step S25 is illustrated in FIG. 11.

FIG. 11 illustrates a display example of a rating screen in the information support terminal 200. The rating screen is a screen for prompting the user to perform a rating for determining the rating of the video of the shot take. The rating screen is an example of an rating screen in the information support terminal 200 according to the present embodiment.

As illustrated in FIG. 11, for example, the rating screen includes an information display field 40 for a captured video, an OK button 41, a KEEP button 42, and an BAD button 43 as rating options. The information display field 40 displays information related to the video of the shot take, and includes, for example, a thumbnail image of the video of the take, a cut number associated with the take, and the number of takes.

The OK button 41 indicates, for example, a rating “OK” indicating that the user has determined to want to adopt the take for the corresponding cut. The KEEP button 42 indicates, for example, a rating “KEEP” on which it is difficult for the user to determine whether or not to adopt the take. The BAD button 43 indicates, for example, a rating “BAD (No Good)” in which the user has determined that it is clear that the take is not adopted. In the present embodiment, the rating “BAD” is an example of a first rating, and the ratings “OK” and “KEEP” are examples of a second rating.

In the recording mode processing (S25) in the present embodiment, every time video shooting of one take is performed, for example, the rating screen of FIG. 11 is displayed to acquire rating information indicating a rating of the user of the take. Based on the rating result of the recording mode processing (S25), the controller 210 performs the cut list generation processing (S21) again as illustrated in FIG. 10 to update the cut list 30. Details of the processing of step S25 will be described later.

The transition operation to the playback mode ((III) in S23) is a user operation for shifting to the playback mode, which is an operation mode for playing and displaying a video captured with respect to the selected cut, and is, for example, an operation of the playback mode button 35. Additionally or alternatively, the transition operation to the playback mode may be a swipe operation in a direction opposite to the transition operation to the recording mode among the +X direction and-X direction of the cut selection screen. Furthermore, the playback mode button 35 may be omitted.

When the transition operation to the playback mode is input ((III) in S23), the controller 210 executes processing of playing videos of various takes related to the selected cut as the playback mode (S26). In the playback mode processing (S26) in the present embodiment, re-rating for changing the evaluation on the video of each take can be executed. Based on the re-rating result of the playback mode processing (S26), the controller 210 performs the cut list generation processing (S21) again to update the cut list 30.

The filtering operation ((IV) in S23) is a user operation for narrowing down the cuts to be displayed in the cut list 30, and is, for example, an operation of the filter button 32. When a filtering operation is input ((IV) in S23), the controller 210 acquires a condition for filtering cuts to be displayed in accordance with user's selection (S27).

The information support terminal 200 according to the present embodiment uses the scene in the storyboard information of each cut as a filtering condition for the cut list 30. The controller 210 performs the cut list generation processing (S21) again based on the scene acquired as the filtering condition. Thus, the cut list 30 is updated so as to be limited to the cut icon 3 corresponding to the scene of the filtering condition.

The end operation ((V) in S23) is a user operation for ending the cut shooting function, and is, for example, an operation of the return button 15 on the cut selection screen (FIG. 9). When an end operation is input ((V) in S23), the controller 210 causes the display 240 to transition from the cut selection screen to the function selection screen (FIG. 4), for example, and ends the processing shown in this flowchart.

According to the above processing, the user of the present system 10 can perform video shooting of a desired cut (S25) or perform playback display (S26) with checking various cuts on the cut selection screen (FIG. 9) in the cut shooting function of the information support terminal 200 (S24). In this way, the user can easily manage the video shooting of the plurality of cuts in the scenario.

On the cut selection screen according to the present embodiment, each of the cut icons 3 is identified and displayed depending on whether or not the shooting is completed, and thus, it is possible to suppress a situation in which a user forgets to shoot a cut. As the identification display of whether or not imaging of each cut is completed is performed so as to reflect the rating of the video of each take by the user, it becomes easier to ensure the video quality according to the intention of the user. Such rating is performed every time a take is captured (S25), and re-rating can be performed in the playback mode (S26). As a result, it is possible to easily realize quality management of video shooting according to the intention of the user.

Further, the cut selection screen according to the present embodiment (FIG. 9) is not limited to the update of the cut list 30 according to the rating/re-rating of cuts as described above (S25, S26, S21), and can also be updated according to the filtering of the display target (S27, S21). As a result, the user can efficiently use a desired cut on the cut selection screen at the site of video shooting, for example, and can easily use the cut shooting function of the present system 10.

In the cut shooting function according to the present embodiment, communication connection with the digital camera 100 may be managed, and for example, a button for managing communication connection may be provided on the cut selection screen. When the communication connection with the digital camera 100 is not established, the controller 210 may disable the operation to transit to the recording mode ((II) in S23).

### 2.2.2. Recording Mode

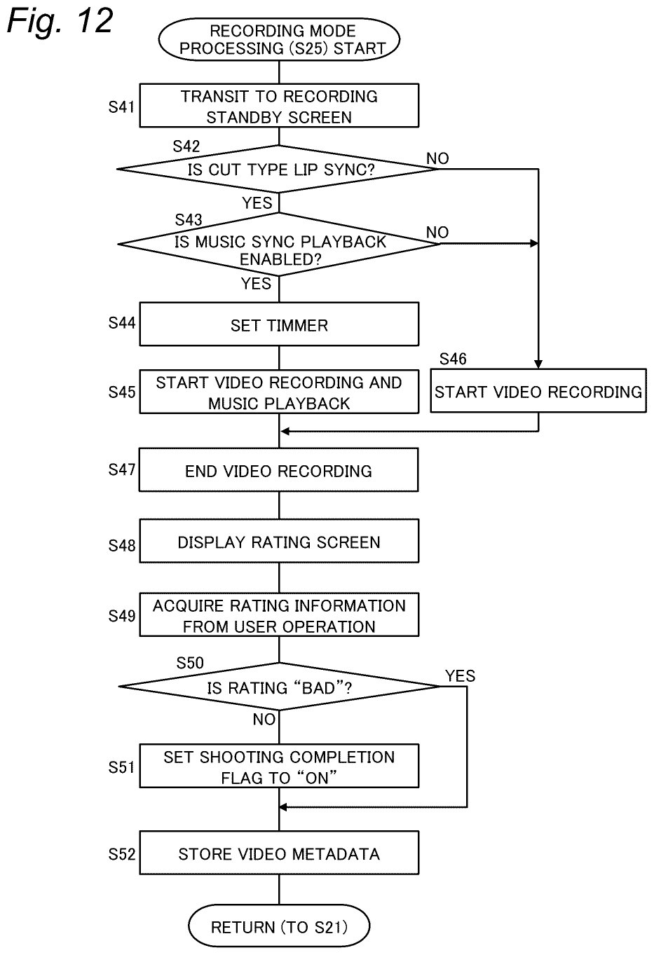

Details of the recording mode processing in step S25 of FIG. 10 will be described with reference to FIGS. 12 to 15.

FIG. 12 is a flowchart illustrating recording mode processing (S25) in the present system 10. The processing illustrated in the flowchart of FIG. 12 is started, for example, when a transition operation to the recording mode is input on the cut selection screen (FIG. 9) ((II) in S23).

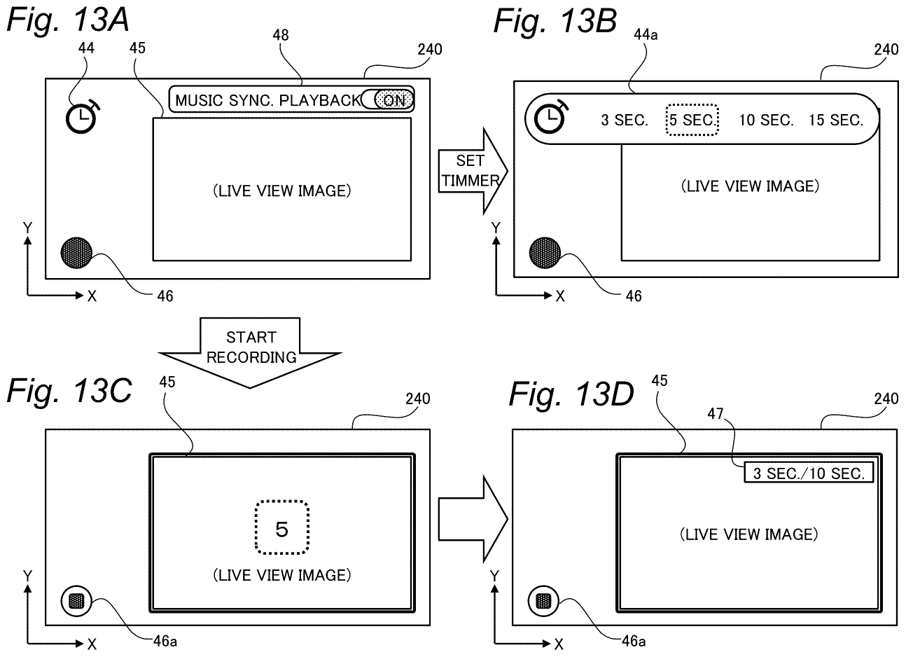

First, the controller 210 of the information support terminal 200 shifts to the recording mode and causes the display 240 to transition to a screen for waiting for video shooting (S41). FIG. 13A illustrates a display example of the information support terminal 200 in step S41.

As illustrated in FIG. 13A, such a recording standby screen displayed in step S41 includes a timer button 44, a live view image 45, a recording button 46, and a synchronous playback button 48, for example. The timer button 44 receives, for example, a user operation for setting a timer period for performing timing at the start of imaging. The recording button 46 receives a user operation for starting shooting and recording of a video. The synchronous playback button 48 receives, for example, a user operation of switching validity or invalidity of the synchronous playback function of playing the sound of the music according to the timer period at the start of imaging.

Furthermore, in the information support terminal 200, communication connection with the external speaker via the communication interface 250 may be managed, and for example, information according to the state of the communication connection may be displayed on the recording standby screen.

In the present system 10, for example, when shifting to the recording mode, the controller 210 of the information support terminal 200 requests the digital camera 100 to transmit the live view image 45 via the communication interface 250 (S41). For example, in the recording mode, the controller 210 sequentially receives the image data of the live view image 45 from the digital camera 100 via the communication interface 250, and displays the live view image 45. Furthermore, the controller 210 receives, for example, sound data of a sound collection result of the microphone 160 from the digital camera 100 in a timely manner.

The controller 210 determines whether or not the cut type is the lip synch based on the cut allocation data D1 for the cut selected on the cut selection screen (FIG. 9) as a target for the recording mode (S42).

In a case where the cut type is the lip synch (YES in S42), the controller 210 determines whether or not the synchronous playback function of the music in video shooting is turned on, that is, enabled according to the result of the user operation on the synchronous playback button 48, for example (S43).

When the synchronous playback function is turned on (YES in S43), for example, the timer period is set according to the user operation of the timer button 44 (S44). FIG. 13B illustrates a display example of the information support terminal 200 in step S44. The setting of the timer period may be performed for each take or may be uniform for each cut.

FIG. 13B illustrates a timer selection field 44a displayed in response to the operation of the timer button 44 on the recording standby screen of FIG. 13A. FIG. 13B illustrates an example in which the timer period is set to “5 seconds” in the timer selection field 44a. The timer selection field 44a includes an option indicating a numerical value of the timer period, such as “5 seconds”. In step S44, when receiving the user operation in the timer selection field 44a in the user interface 230, the controller 210 sets the timer period according to the user operation, and causes the display 240 to transition from the screen of FIG. 13B to the screen from FIG. 13A.

For example, after the timer period is set (S44), the controller 210 performs various types of control in response to the user operation on the record button 46 so as to start shooting and recording of a video of one take associated with the selected cut and playback of the music (S45). For example, in step S45, the controller 210 instructs the digital camera 100 to start shooting and recording of the video via the communication interface 250. Furthermore, the controller 210 instructs the speaker 270 to output a sound so as to play the music based on audio source data of the music stored in the storage 221, for example. A display example of the information support terminal 200 in step S45 is illustrated in FIGS. 13C and 13D.

FIG. 13C illustrates a video shooting screen in a case where the recording button 46 is operated in a case where the timer period is set as in the example of FIG. 13B. FIG. 13D illustrates a video shooting screen after the timer period from FIG. 13C. At the time of operation of the recording button 46 (S45), the controller 210 performs a countdown of the lapse of time by the set timer period, and superimposes and displays the time on the live view image, for example. In this example, the video recording is performed in a period including such a timer period.

As illustrated in FIGS. 13C and 13D, for example, the video shooting screen in step S45 includes a live view image 45, a time display field 47, and a recording stop button 46a. For example, highlighting is performed on the live view image 45 of the video shooting screen of FIG. 13D by a frame display or the like indicating that the recording is being performed is performed. For example, on the video shooting screen of FIG. 13D, the recording stop button 46a receives a user operation for stopping shooting and recording of a video. For example, the time display field 47 displays the shooting duration of the selected cut in the cut allocation data D1 in comparison with an elapsed time from the start of shooting the video of the take associated with the selected cut.

In step S45, the controller 210 controls the display 240 to switch the display from the recording standby screen (FIG. 13A) to the video shooting screen (FIGS. 13C and 13D). Furthermore, the controller 210 records a video file indicating the live view image 45 sequentially received from the digital camera 100 after the operation of the recording button 46 in the memory 220 of the information support terminal 200 (S45). The recorded video file includes, for example, audio data generated from a sound signal collected by the microphone 160 in synchronization with video shooting by the digital camera 100.

Furthermore, the controller 210 determines the file name of the video file based on, for example, the cut allocation data D1 and the number of takes that have been shot for the selected cut. The controller 210 may provide the determined file name in the instruction to the digital camera 100. The controller 135 of the digital camera 100 starts shooting of a video in accordance with an instruction from the information support terminal 200 received via the communication module 155, for example.

In this processing, the controller 135 repeats the imaging operation of the image sensor 115 and records the video data of the shooting result in the memory card 142 via the card slot 140, for example. The video data includes, for example, audio data of the sound collection result by the microphone 160. The controller 135 may start sound collection synchronized with video shooting in the digital camera 100 in response to the shooting instruction from the information support terminal 200.

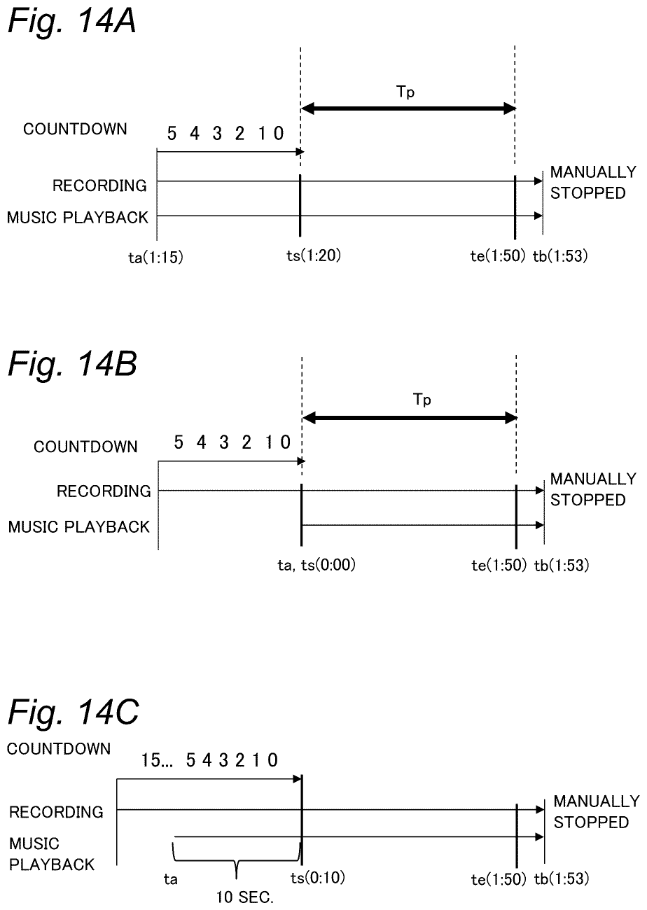

In step S45, in addition to the countdown display as illustrated in FIG. 13C, the information support terminal 200 plays the music according to the set timer period. With respect to the selected cut of the lip synch, the controller 210 plays the music range set by the processing of steps S13 and S14 in the scenario creation function (FIG. 5) so as to synchronize with video shooting based on the cut allocation data D1. FIGS. 14A to 14C are diagrams for explaining the synchronous playback function in the information support terminal 200.

FIG. 14A illustrates an example in which the start time ts of the set music range Tp is later than the time of the beginning of the music in the audio source data by the timer period or more. In the example of FIG. 14A, at the same time as the start of the countdown display, the controller 210 plays the music from the time ta before the music range Tp by the timer period based on the audio source data of the music. For example, in step S45, the controller 210 determines the playback start time ta in such pre-playback of the music based on the music range Tp and the timer period set in step S44.

FIG. 14B illustrates an example in which the start time ts of the music range Tp coincides with the time of the beginning of the music. In the example of FIG. 14B, the controller 210 determines the playback start time ta of the music as the start time ts of the music range Tp, and performs only the countdown display and the video recording in the timer period. FIG. 14C illustrates an example in which the timer period is set to “15 seconds” and the start time ts of the music range Tp is set to 10 seconds after the beginning of the music. In the example of FIG. 14C, the controller 210 determines the playback start time ta of the music 10 seconds before the start time ts of the music range Tp, and performs the pre-playback of the music further from the playback start time ta after the countdown display and the video recording are started in the timer period.

As described above, in step S45, the controller 210 performs the pre-playback from the start time ta at which the music can be played according to the timer period and the start time ts of the music range Tp set to the cut of the lip synch. Furthermore, in this example, the video recording and the music playback are performed until the recording stop time tb regardless of whether the recording stop time tb is later than the end time te of the music range Tp from the playback start time ta, the recording stop time tb being a time at which the video recording is stopped by the operation of the recording stop button 46a.

In a case where the music synchronous playback is not turned on (NO in S43), the controller 210 performs various types of control in response to the user operation of the record button 46 so as to start shooting and recording of the video associated with the selected cut, for example, in the processing similar to step S45 (S46). In this case, the controller 210 does not particularly perform the countdown display as illustrated in FIG. 13C and the music playback described in FIGS. 14A to 14C, for example, and causes the display 240 to transition to the video shooting screen as illustrated in FIGS. 13A to 13D.

Furthermore, also in a case where the cut type of the selected cut is not the lip synch (NO in S42), the controller 210 starts shooting and recording of a video associated with the cut in response to the user operation of the record button 46 (S46).

In this example, the controller 210 does not determine whether the synchronous playback function is enabled or disabled (S43) and does not set the timer period (S44) for the cut of the B-roll which is not lip synch (NO in S42). For example, in a case where the mode shifts to the recording mode in a state where the cut of the B-roll is selected, the information support terminal 200 may hide the timer button 44 on the recording standby screen of FIG. 13A and may not receive the user operation for setting the timer period.

After the start of the shooting and recording of the video (S45,S46), the controller 210 performs various controls to stop the shooting and recording being executed according to the user operation of the recording stop button 46a (S47). For example, in step S47, the controller 210 instructs the digital camera 100 to stop shooting and recording of a video via the communication interface 250. Furthermore, the controller 210 stops video recording of the live view image 45 in the information support terminal 200 (S47). The controller 135 of the digital camera 100 ends shooting a video in accordance with an instruction from the information support terminal 200. Furthermore, for example, in step S47 after the start of the playback of the music (S45), the controller 210 instructs the speaker 270 to stop the audio output.

Furthermore, in order to prompt the user to rate the video of the take shot as described above, the controller 210 displays a rating screen on the display 240, for example, as illustrated in FIG. 11 (S48).

The controller 210 receives a user operation of the various buttons 41 to 43 on the rating screen as illustrated in FIG. 11, for example, and acquires the rating of the user as a result of the rating of the video of the shot take (S49). In the present embodiment, every time a video of one take is shot, a user can arbitrarily select a desired rating from the above three types of rating “OK”, “KEEP”, and “BAD” for a video shot without interfering with rating of a video of another take in particular.

The controller 210 determines, for example, whether or not the rating is “BAD” based on the acquired rating of the user (S50). For example, in a case where the rating of the user is “OK” or “KEEP”, the determination in step S50 is “NO”.

In a case where the acquired rating of the user is not “BAD” (NO in S50), the controller 210 sets the shooting completion flag of the cut associated with the take (i.e., the selected cut) in the cut allocation data D1 to “ON” (S51). For example, in a case where the number of takes of the video is “1”, or in a case where a rating of a video of an existing take is “BAD” in the number of takes equal to or greater than “2”, the shooting completion flag is switched from “OFF” to “ON” by the execution of step S51.

On the other hand, in a case where the acquired rating of the user is “BAD” (YES in S50), the controller 210 proceeds to step S52 without particularly updating the setting of the shooting completion flag. Thus, for example, when the shooting completion flag of the corresponding cut is in the OFF state when the video having the rating “BAD” is captured, the OFF state is maintained. Further, for example, when a video of a take captured in the past has “KEEP” or “OK”, and thus the shooting completion flag is in an ON state, the ON state is maintained.

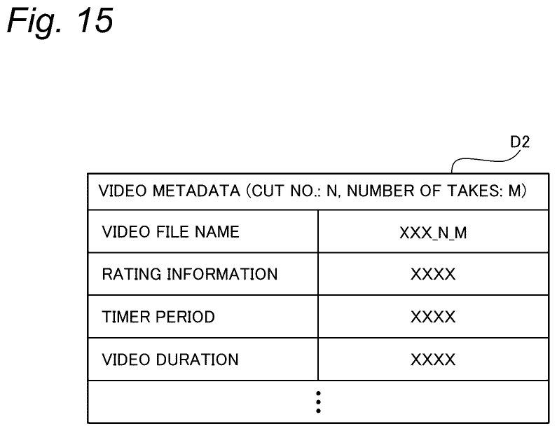

The controller 210 generates metadata of a video of a take captured as described above, and records the metadata in, for example, the cut allocation data D1 in the memory 220 (S52). Such video metadata D2 is illustrated in FIG. 15.

For example, as illustrated in FIG. 15, the video metadata D2 includes “video file name”, “rating information”, “timer period”, and “video duration”. The controller 210 includes the video file name determined to reflect the number of takes with respect to the video captured in steps S45 to S47, the rating of the user acquired in step S49, and the timer period set in step S44 in the video metadata D2. The controller 210 generates the video metadata D2 to further include the shooting duration of the video as the video duration from the start (S45,S46) of shooting and recording the video to the end (S47) of the shooting and recording.

The controller 210 stores the generated video metadata D2 in the video metadata list in the cut associated with the video in the cut allocation data D1 (FIG. 8) (S52). The video metadata D2 is not particularly limited to the above, and may include, for example, the number of takes of the video in addition to or instead of the video file name.

For example, the controller 210 ends the recording mode processing (S25) by storing the video metadata D2 (S52), and proceeds to step S21 of FIG. 10.

According to the recording mode processing (S25) described above, the present system 10 can capture and record a video of one take of the selected cut and prompt the user to rate the cut (S45 to S49). Furthermore, in a case where the cut is set to the lip synch (YES in S42), the present system 10 can play the music synchronized with the shooting and recording of a video according to the music range associated with the cut (S43, S45). In this case, according to the timer setting (S44), before the start of the video recording, the music is played from the time before the music range Tp of the cut in addition to the countdown display (see S45, FIGS. 14A to 14C). This facilitates the video shooting in accordance with the music.

The present system 10 manages the video shooting completion flag of the cut based on the acquired rating information (S50, S51). In this manner, the rating information of the user for each take can be appropriately reflected in the management of whether or not the cut is in the shooting completion state. According to the recording mode processing (S25) according to the present embodiment, the information support terminal 200 can control the shooting and recording of the video by the digital camera 100 to realize the management of the video shooting.

In the rating (S48 and S49) of the video of each take, a plurality of takes may have the same rating among a plurality of takes associated with the same cut. For example, a video of a plurality of takes for the same cut may have a rating “OK”.

In addition, the rating screen displayed in step S48 may be displayed as a dialog. For example, the controller 210 may control the display 240 to superimpose and display the dialog of the rating screen on the display screen before and after step S47.

The recording standby screen in the recording mode (FIG. 13A) may further include, for example, a return button 15 for an operation of returning the screen transition to the cut selection screen. Furthermore, such a return operation may be a swipe operation in a predetermined one of the +X direction and-X direction of the video management screen. Furthermore, the information support terminal 200 may shift to the playback mode by a swipe operation in the opposite direction.

When the selected cut is set to the B-roll (NO in S42), the information support terminal 200 may display the timer button 44 on the recording standby screen (FIG. 13A), or may receive a user operation for setting the timer period similarly to step S44. Further, also in a case where the music synchronous playback is not turned on (NO in S43), the timer setting may be performed similarly to step S44. In such a case, in step S46, the countdown display may be performed in the set timer period together with the start of the video recording. The execution order of steps S43 and S44 is not limited to the above example, and for example, the determination similar to step S43 may be performed after the timer is set without depending on whether the music synchronous playback is enabled or disabled.

For the cut of the lip synch, the information support terminal 200 may not acquire audio data of the sound collection result by the microphone 160 or the like from the digital camera 100 in the shooting and recording of the video (S45). Also, sound collection by the microphone 160 or the like may not be performed in shooting and recording for the cut of the lip synch.

### 2.3. Export Function

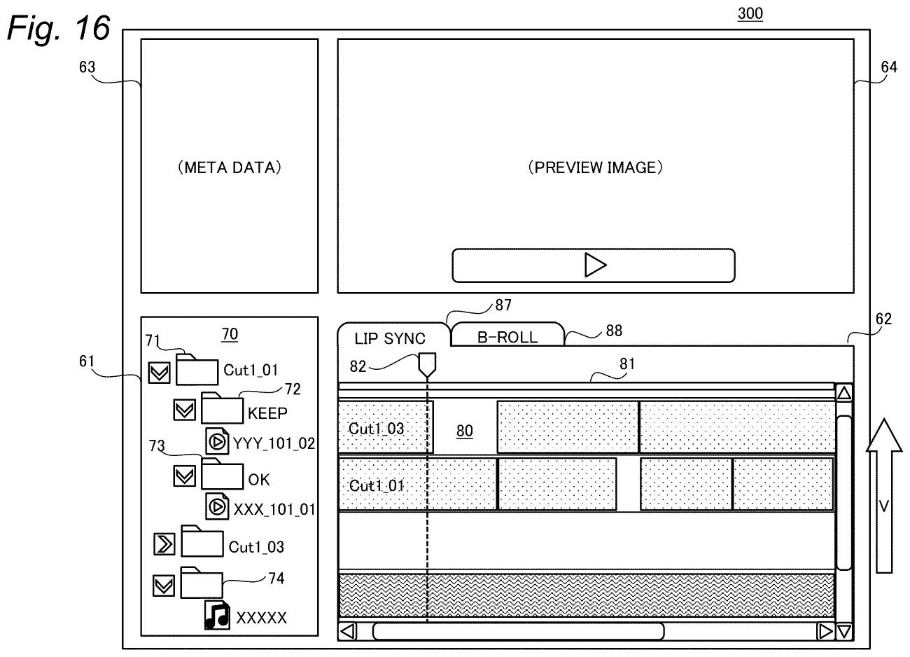

An outline of the export function in the information support terminal 200 of the present system 10 will be described with reference to FIG. 16.

FIG. 16 illustrates a display example of a video editing screen in the video editing PC 300 of the present system 10. The video editing PC 300 (FIG. 1) reads, into predetermined editing software, the management data output by the export function by the information support terminal 200, the audio source data of the music, and video data of the shooting result by the digital camera 100, and displays the video editing screen as illustrated in FIG. 16, for example. The editing software may be a variety of non-linear editing (NLE) software, such as DaVinci Resolve, Adobe Premiere Pro, Final Cut Pro, or Vegas Pro.

The video editing screen illustrated in FIG. 16 includes a material display field 61, a timeline editing field 62, a metadata display field 63, and a preview image 64. The video editing screen is a screen for the user to perform various video editing operations, and is an example of an editing screen in which the video editing PC 300 is an example of an external device.

The material display field 61 displays a list of video data read as a material of video editing in the video editing PC 300 and audio source data of the music (i.e., video material). In the present system 10, for example, the material display field 61 displays a folder that manages the video material for each cut, that is, a video folder 70, which will be described later in detail.

The timeline editing field 62 displays a video timeline 80 including a plurality of video materials arranged along a time axis 81, and receives a user operation of editing a video work combining the video materials in the video timeline 80. The video timeline 80 has a track for each row in which video materials are arranged along the time axis 81. In the video timeline 80, the plurality of tracks are arranged in a direction V intersecting the time axis 81, and different video materials can be arranged in the respective tracks at the same position on the time axis 81. Hereinafter, the +V side in the direction V of such arrangement may be referred to as an upper side, and the opposite −V side may be referred to as a lower side.

The timeline editing field 62 according to the present embodiment displays a video timeline 80 for the lip synch and a video time line 80 for the B-roll differently from each other. The video timeline 80 for the lip sync includes a video material mainly related to the cut of the lip synch and the audio of the music. The video timeline 80 for the B-roll includes only a video material related to the cut of the B-roll. The timeline editing field 62 of this example includes a lip synch tab 87 and a B-roll tab 88 for displaying the video timeline 80 for the lip synch and the video timeline 80 for the B-roll, respectively, switching between the respective video timelines 80. In the example of FIG. 16, the lip synch tab 87 is selected to display the video timeline 80 for the lip synch.

The metadata display field 63 displays metadata of the video material displayed in the material display field 61 or the timeline editing field 62. The preview image 64 displays an image in the video material at a timing corresponding to the position of the playback head 82 arranged on the time axis 81 in the video timeline 80.

For example, on the video editing screen (FIG. 16), the user can adjust the arrangement of the video material in the timeline editing field 62 and arrange a new video material from the material display field 61 in the video timeline 80, checking the preview image 64. For example, in the video timeline 80 for the lip synch, a video material for each cut can be arranged in association with the audio of the music. In this way, the user operation of editing a video work is performed as an editing operation in the present system 10.

The information support terminal 200 according to the present embodiment generates, in the export function, the management data to manage the video material in accordance with setting of the cut associated with the music range in the cut allocation data D1, from a viewpoint of facilitating the user to perform the editing operation of a video work as described above. For example, the information support terminal 200 generates the management data reflecting a synchronous relationship between the cut and the music range after executing the cut shooting function capable of synchronously playing the music range set to the cut of the lip synch. Based on the management data, in the present system 10, the video material for each cut read by the video editing PC 300 can be arranged in the video timeline 80 according to the synchronization relationship with the music range. Therefore, the present system 10 can facilitate the process of editing a video in accordance with the music. This also leads to improve a processing efficiency for the process in the video editing PC 300.

As a typical function of this type of the editing software, for example, by playing the audio of the music together with shooting and recording of the video, the video material may be arranged in synchronization with the audio of the music in the video timeline 80 in a case where a sound collection result of the audio is included in the recorded video data. In such a function, for example, as described in JP 2013-012262 A, a sound specified by the analysis of the sound collection result in the video data is compared with a music sound indicated by the audio source data of the music read into the editing software, aiming to synchronize a video image in the video data and the music sound. However, in the synchronization by the analysis of the sound collection result, a difficulty is concerned in accurate synchronization due to an influence of noise such as environmental sound at the time of sound collection, or an increased processing load for the analysis in a PC or the like that executes the editing software.

On the other hand, by the export function in the present system 10,, the management data of the video material is output so as to reflect the setting of the cut associated with the music range, and for example, the synchronization can be accurately performed based on the management data without analyzing the sound collection result in the process of editing a video. Furthermore, for example, it is possible to avoid an extra user operation such as inputting a command for generating information on the synchronization when shooting and recording a video. Hereinafter, the export function of the present system 10 will be described in detail.

### 2.3.1. Overall Operation of Export Function

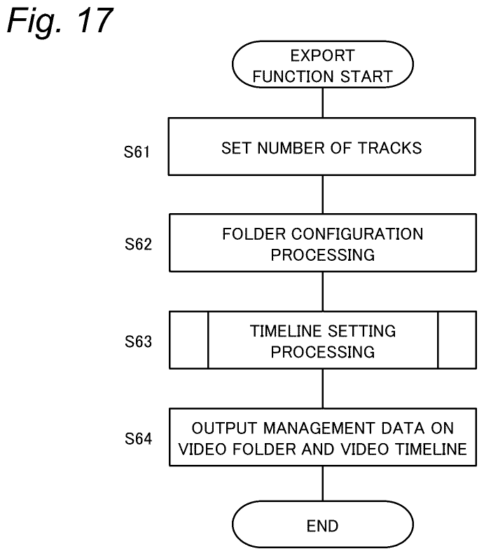

The overall operation of the export function in the present system 10 will be described with reference to FIGS. 17 to 19.

FIG. 17 is a flowchart illustrating an operation of the export function in the present system 10. Each processing of the flowchart of FIG. 17 is executed by the controller 210 of the information support terminal 200, for example. The processing of this flow is started, for example, when the export button 13 on the function selection screen (FIG. 4) is operated in a state where the cut allocation data D1 including the video metadata D2 by the cut shooting function is stored in the memory 220.

First, for example, the controller 210 of the information support terminal 200 sets the number of tracks in each of the video timeline 80 for the lip synch and the video timeline 80 for the B-roll based on the cut allocation data D1 (S61). For example, the number of tracks in the video timeline 80 for the lip synch is set according to the number of cuts whose cut type is the lip synch and the shooting completion flag is turned on in the cut allocation data D1.

Then, for example, the controller 210 configures the video folder 70 displayed in the material display field 61 of the video editing screen (FIG. 16) based on the cut allocation data D1 (S62). As illustrated in FIG. 16, for example, the video folder 70 obtained by such a folder configuration processing (S62) includes a folder for each cut, that is, a cut folder 71, and a KEEP folder 72 and an OK folder 73 provided in each cut folder 71. The video folder 70 illustrated in FIG. 16 further includes a music folder 74 that stores audio source data of music.

The KEEP folder 72 stores a video file having a rating “KEEP” in the video material of the cut. The OK folder 73 stores a video file having a rating “OK” in the video material of the cut. In the folder configuration processing of step S62, a directory structure for configuring the video folder 70 is automatically written in the management data by the controller 210.

In the folder configuration processing (S62), for example, a file name and detailed information of each video file are further written in the management data by the controller 210. The detailed information of the video file includes, for example, a time length of the video material (i.e., the video duration), a recording date and time, a timer period, and the like. For example, in step S62, the controller 210 generates management data for the video folder 70.

The icon indicating the video file in the video folder 70 is an example of the video information in the present embodiment. In the material display field 61, an icon indicating the video timeline 80 may be displayed together with the video folder 70 as described above. Furthermore, in the example of FIG. 16, the video icon in the cut folder 71 with the cut number “1” is displayed, but according to the video folder 70, other video icons in the cut folder 71 can also be displayed as appropriate by a user operation on the material display field 61.

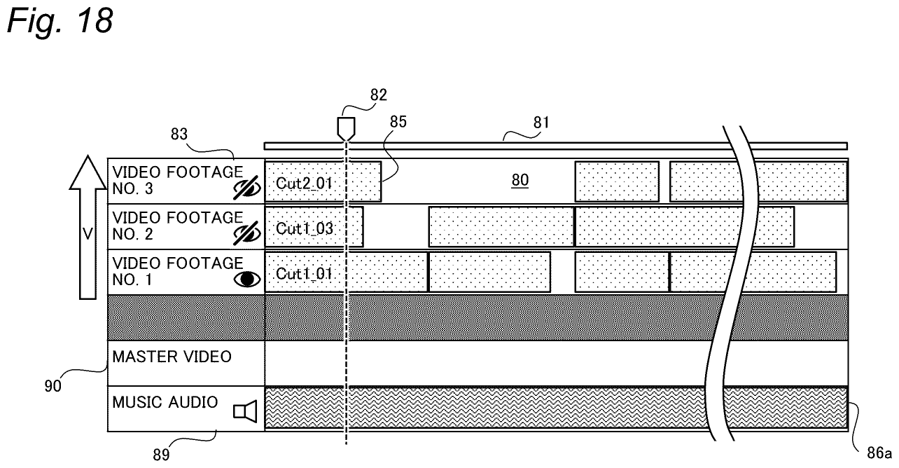

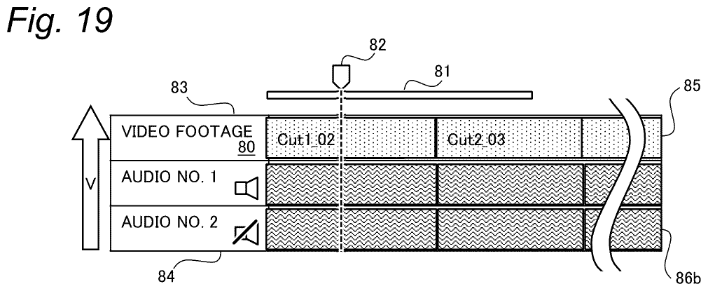

The controller 210 sets the video timeline 80 displayed in the timeline editing field 62 (FIG. 16) at the start of video editing by the user based on the setting of the number of tracks (S61) and the result of the folder configuration processing (S62) (S63). The video timeline 80 obtained by such timeline setting processing (S63) is illustrated in FIGS. 18 and 19.

FIG. 18 is a diagram illustrating an example of the video timeline 80 for the lip synch on the video editing screen. As illustrated in FIG. 18, for example, the video timeline 80 for the lip synch includes video footage tracks 83 arranged in accordance with the number of tracks that is set according to the number of cuts, one music audio track 89, and one master video track 90. The video footage track 83 includes, as footages for the video editing, video clips 85 that indicate video images in the video file of each cut. The music audio track 89 includes an audio clip 86a indicating the audio of the music. The master video track 90 is set as a blank track, for example, in the timeline setting processing (S63), and receives an editing operation of arranging the video clip 85 to be included in the video work in the video editing PC 300.

In the video timeline 80 for the lip synch, for example, as illustrated in FIG. 18, the video footage track 83 corresponding to each cut is arranged in the direction V intersecting the time axis 81. As a result, for example, the video clip 85 on each video footage track 83 is displayed making the video clip 85 easy to see with respect to the time in the audio clip 86a of the music audio track 89. In the export function of this example, the management data is generated so as not to read the audio in the video file of the cut of the lip synch into the video timeline 80 for the lip synch, for example.

FIG. 19 is a diagram illustrating a video timeline 80 for the B-roll on the video editing screen. The video timeline 80 for the B-roll includes, for example, one video footage track 83 and audio tracks 84 of the number of tracks, the audio tracks 84 respectively corresponding to each of sound signals indicating the sound collection results by the built-in microphone 160 and the external microphone of the digital camera 100. The video footage track 83 includes a video clip 85 for each cut. The audio track 84 includes an audio clip 86b indicating audio corresponding to a video in the video file. Each of the video/audio clips 85 and 86b is an example of video information in the present embodiment.

In the video timeline 80 for the B-roll, for example, as illustrated in FIG. 19, video clips 85 of each cut are arranged in one video footage track 83 in a direction along the time axis 81, and an audio clip 86b corresponding to a sound signal is displayed for each audio track 84. As a result, for example, one or more audio clips 86b each corresponding to the video of the video clip 85 can be displayed in each video clip 85 in an easily viewable manner.

In the timeline setting processing of step S63, each video timeline 80 is automatically set so that the video/audio clips 85 and 86a are arranged in the video/audio tracks 83 and 84 in synchronization with respect to the cut of the lip synch, based on the setting in the cut allocation data D1. Details of the timeline setting processing (S63) will be described later.

The controller 210 outputs the management data including the results of the folder configuration processing (S62) and the timeline setting processing (S63) (S64), and ends the processing illustrated in the flowchart of FIG. 17. The controller 210 stores the management data in the storage 220, for example.

According to the processing of the export function described above, the information support terminal 200 of the present system 10 can provide the video folder 70 and the video timeline 80 which can facilitate the process of editing the video of various cuts shot by the user in accordance with the scenario in the video editing PC 300 (S62, S63).

For example, according to the video timeline 80 for the lip synch (FIG. 18) provided by the present system 10, the video material of each cut is arranged in the video footage track 83 in synchronization with the audio clip 86a of the music audio track 89. Therefore, for example, the user can perform video editing in a state where the video footage and the audio are synchronized with each other without executing the function of the editing software for synchronization.

In the present system 10, the video folder 70 can adopt various configurations. For example, the OK folder 73 and the KEEP folder 72 may not necessarily be provided in all the cuts. Furthermore, in the present system 10, a folder for storing a video of a take of the rating “BAD” may be further provided in the video folder 70.

### 2.3.2. Timeline Setting Processing

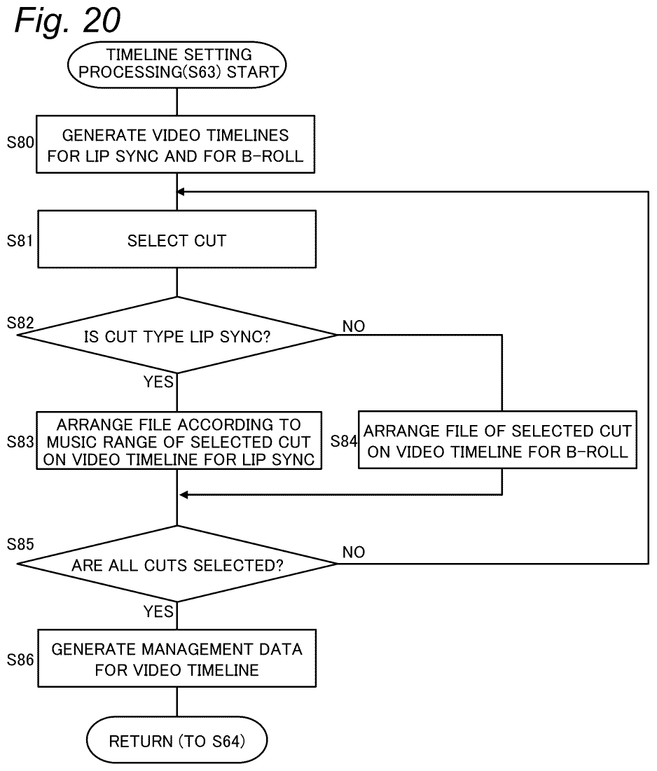

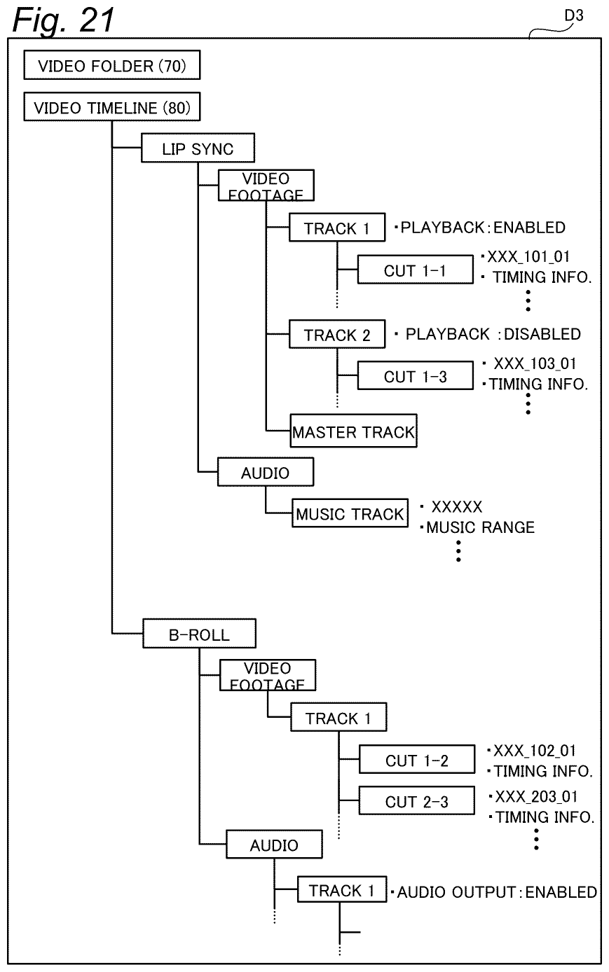

Details of the timeline setting processing in step S63 of FIG. 17 will be described with reference to FIGS. 20 to 21.

FIG. 20 is a flowchart illustrating the timeline setting processing (S63) in the present system 10. FIG. 21 illustrates a data structure of the management data D3 according to the timeline setting processing (S63). The management data D3 illustrated in FIG. 21 includes a portion of the video folder 70 generated by the folder configuration processing (S62) and a portion of the video timeline 80 generated by the timeline setting processing (S63).

First, the controller 210 generates video timelines 80 for the lip synch and the B-roll for arranging the video materials as illustrated in FIGS. 18 and 19, for example (S80). For example, the controller 210 generates the video timeline 80 for the lip synch so as to arrange the audio clip 86a in the music audio track 89 based on the audio source data of the music. For example, the controller 210 determines the time length or the like of the music audio track 89 based on the information indicating the range of music to be included in the video work input in the scenario creation function (see S11 in FIG. 5). In the video timeline 80, a timing to start the playback of the music is set to, for example, a start timing of the video timeline 80.

Furthermore, the controller 210 refers to, for example, the cut allocation data D1, and sets the time length of the video timeline 80 for the B-roll as the sum of the video durations of all cuts of the B-roll (S80).

Next, the controller 210 selects one cut folder 71 from among the plurality of cut folders 71 based on the management data D3 for the video folder 70 obtained by the folder configuration processing (S62), for example (S81). Step S81 is processing for determining the arrangement of the video material in the video timeline 80 for each cut, and is performed in ascending order for the cut number, for example.

Based on the cut allocation data D1, the controller 210 determines whether the cut type of the cut corresponding to the selected cut folder 71 is the lip synch (S82).

In a case where the cut type of the selected cut is the lip synch (YES in S82), the controller 210 arranges a target video file associated with the music range of the cut in the video timeline 80 for the lip synch (FIG. 18) based on the cut allocation data D1 (S83). For example, the controller 210 extracts a video file whose recording date and time is the latest from video files of the takes having the rating “OK” or “KEEP” in the cut, as the target video file to be arranged in the video timeline 80.

For example, as repeatedly executing step S84, the controller 210 associates the video footage track 83 with the selected cut of the lip synch in ascending order from the track number “1” in the video timeline 80 for the lip synch (FIG. 18). Furthermore, the controller 210 performs initial setting for playback of the preview image 64 (FIG. 16) in accordance with the video timeline 80 to each video footage track 83. For example, the video footage track 83 and the music audio track 89 of the track number “1” are set to enable the playback display and the audio output, respectively, and the other video footage tracks 83 are set to disable the playback display.

The controller 210 determines the arrangement of the video material in the video footage track 83 for the selected cut based on, for example, the management data D3 for the video folder 70 in addition to the cut allocation data D1 (S83). For example, the controller 210 first determines various types of timing information on a video material with the latest recording time and has the highest rating for the cut. For example, the controller 210 determines, referring to the timer period of the video material, a start timing to be adopted in the video timeline 80 from the video material. For example, when the timer period is “5 seconds”, a timing five seconds after the beginning of the video material is determined as the adopted start timing.

Furthermore, based on the music range associated with the selected cut in the cut allocation data D1, the controller 210 sets a timing at which the playback of the video material starts and a timing at which the playback ends in the video timeline 80 for the lip synch (S83). For example, regarding the cut of the lip synch, the playback start timing of the video material is set to a start timing of the corresponding music range. Furthermore, the playback end timing of the video material is set to, for example, a timing after the playback start timing by a playback period of the video material. When the timer period is set, the playback period is managed by excluding the timer period from the time length of the entire video such as the video duration.

The controller 210 arranges the video clip 85 of the video material corresponding to the extracted video file in the video footage track 83 so as to reflect the various timing settings as described above (S83).

The controller 210 determines whether or not such an arrangement setting is completed for all cuts to be arranged in the video timeline 80, referring to the shooting completion flag in the cut allocation data D1, for example (S85).

When a cut for which the arrangement setting is not completed (NO in S85), the controller 210 performs the processing in and after step S81 again for the unset cut.

When the cut type of the cut selected in step S81 is not the lip synch (NO in S82), the controller 210 arranges the video file of the cut in the video timeline 80 for the B-roll (FIG. 19) (S84). The controller 210 refers to, for example, detailed information of a video file extracted similarly to step S83, and manages a time range corresponding to the cut in the video timeline 80. The time range of the cut in the video timeline 80 is managed as a playback period of a video file to be arranged, for example.

In step S84, for example, as illustrated in FIG. 19, the controller 210 performs initial setting for playback of the preview image 64 in accordance with the video timeline 80 on each audio track 84. For example, the audio track 84 with the track number “1” is set to enable audio output, and the other audio tracks 84 are set to disable. In each of the video timelines 80 in FIGS. 18 and 19, the validity/invalidity of the playback display/audio output can be appropriately switched by the video editing PC 300 according to a user operation on the video editing screen, for example.

The controller 210 determines an arrangement of the video material in the video footage track 83 for the cut based on the management data D3 of the video folder 70, for example (S84). For example, in each video material, the controller 210 determines a start timing to be adopted in the video timeline 80 with reference to the timer period similarly step S83. The controller 210 further sets a playback start timing and a playback end timing of the video material in the video timeline 80 for the B-roll (S84).

For example, the playback start timing is set to the start timing of the video timeline 80 for the B-roll for the first cut, and is set to the end of the time range of the previous cut, that is, the playback end timing of the video file of the cut for the second and subsequent cuts. Furthermore, the playback end timing is set to a timing after the playback start timing by the playback period of the video file. Similarly to the setting of the video clip 85, the controller 210 sets the arrangement of the audio clip 86b of the video material in the audio track 84 (S84).

The controller 210 arranges the video/audio clips 85 and 86b of the video material corresponding to the extracted video file in the video/audio tracks 83 and 84 so as to reflect the various timing settings as described above (S84).

When the arrangement setting for all the cuts is completed (YES in S85), the controller 210 generates the management data D3 for the video timeline 80 by, for example, description in XML language (S86).

In step S86, for example, as illustrated in FIG. 21, the controller 210 provides a tag for each of the lip synch and the B-roll in the tag of the video timeline 80 in the management data D3, and provides a tag for each of the video and the audio. Furthermore, the controller 210 provides a tag for each track under each tag of the video and the audio. Under the tag of the lip synch, for example, the controller 210 provides the a of the master video track 90 in addition to the tag of each track number for the video. In the tag of each track number, the controller 210 writes information on the arrangement setting, such as the video file name and the timing information of the video clip 85 determined in step S83 for the corresponding cut of the lip synch.

For example, the timing information includes the timer period and the video duration in addition to the playback start timing and the playback end timing. The controller 210 writes the playback start timing according to the start time of the music range in the cut allocation data D1 based on the start timing of the video timeline 80 for the lip synch, for example, in the timing information on the cut of the lip synch. As a result, for example, in the video timeline 80 for the lip synch (FIG. 18) in accordance with the period of music, the video clip 85 of each cut can be arranged in the music audio track 89 according to the music range set to the cut. The timing information may be written by the number of frames based on the frame rate of the video file.

In step S86, the controller 210 also provides a tag of the music audio track 89 for the audio under the tag of the lip synch, and writes the file name of the audio source data of the music, the range of the music in the video work, and the like, for example.

Furthermore, under the B-roll, the controller 210 provides a tag for a video of the one track and a tag for each track number corresponding to various microphones or the like for audio. The controller 210 writes, for each cut in the tag of each track, information on the arrangement setting such as video file names and the timing information of the video/audio clips 85 and 86b determined in step S84.

With the management data D3 for the video timeline 80 generated, the controller 210 ends the timeline setting processing (S63) and proceeds to step S64 of FIG. 17.

According to the above timeline setting processing (S63), the information support terminal 200 of the present system 10 can prepare the video timeline 80 in which the video/audio clips 85 and 86 are arranged according to the scenario so as to reflect the setting of the cut preceding to the process of editing a video, or video editing process. Therefore, the user can start video editing without manually arranging the video material shot by the cut shooting function according to the scenario, and from the beginning of the video editing, the user can obtain the video timeline 80 in which the video footage for each cut is arranged in synchronization with the audio of the music (see S83, FIG. 18).

In the above example, in each video timeline 80, a video material of one take is arranged for each cut (see S83, S84, FIG. 18, and FIG. 19). The controller 210 may arrange video materials of a plurality of takes for each cut. For example, in the video timeline 80 for the lip synch, the video material of each take may be arranged in the video footage track 83 with a track number that is continuous for each cut. Furthermore, in the video timeline 80 for the B-roll, video materials of a plurality of takes for each cut may be continuously arranged in the video/audio tracks 83 and 84 in the time axis 81 direction, for example. The management of the time range in step S84 may be performed based on the playback period of the video material arranged in each cut, for example.

### 2.4. Operation of Video Editing PC

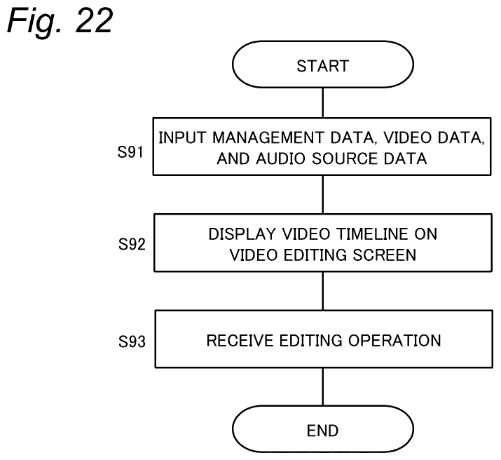

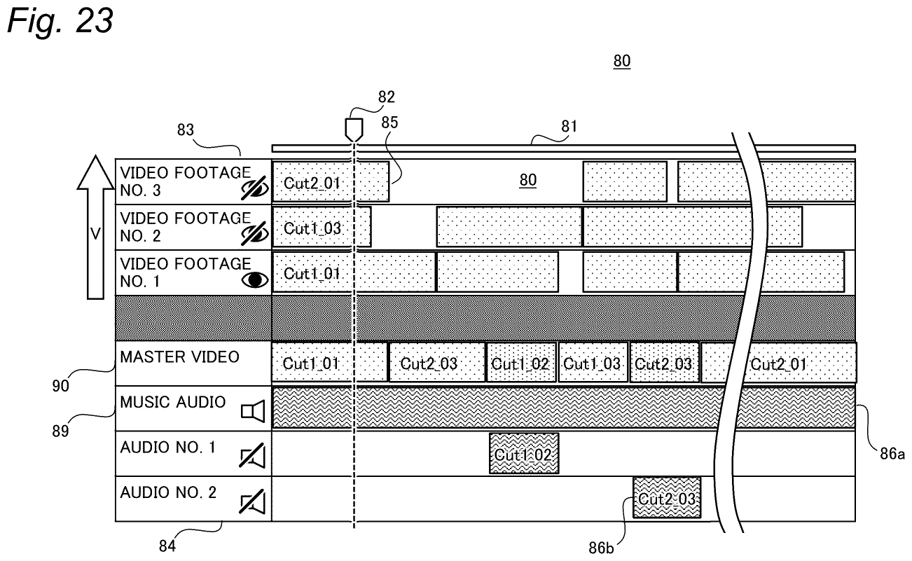

An operation of the video editing PC 300 when the editing operation of the video work is performed based on the management data D3 output by the export function as described above will be described with reference to FIGS. 22 and 23.

FIG. 22 is a flowchart illustrating the operation of the video editing PC 300 in the imaging system 10. FIG. 23 is a diagram for explaining the operation of the video editing PC 300. The processing of this flowchart is executed by the controller of the video editing PC 300 after the management data D3 is output from the information support terminal 200 by the export function in the imaging system 10 (S64 in FIG. 17).

First, the video editing PC 300 inputs the management data D3 and the like (S91). For example, the video editing PC 300 acquires the management data D3 and the audio source data of the music from the information support terminal 200 via the communication interface, and further acquires the video data of the shooting result from the digital camera 100. The management data D3 may be input from the memory card 142 or the like to the video editing PC 300. For example, the management data D3 may be transferred from the information support terminal 200 to the digital camera 100 and input to the video editing PC 300 together with the video data.

The video editing PC 300 reads the video data and the audio source data of the music into the editing software based on the management data D3, and displays the video editing screen as illustrated in FIG. 16, for example (S92). For example, based on the management data D3 (FIG. 21) for the video timeline 80, the video editing PC 300 synchronously arranges the video clip 85 of the cut of the lip synch with respect to the audio clip 86a of the music audio track 89 in the video timeline 80.

The video editing PC 300 receives various editing operations from the user interface on the displayed video editing screen (S93). FIG. 23 illustrates the video timeline 80 for the lip synch in a state where the lip synch tab 87 is selected on the video editing screen (FIG. 16) and an editing operation is performed.

For example, as illustrated in FIG. 23, in the video timeline 80 for the lip synch, video clips 85 of various cuts are arranged in the master video track 90 by the editing operation. In this example, the video clip 85 of the cut of the B-roll and the corresponding audio clip 86 can be copied from the video timeline 80 for the B-roll to the video timeline 80 for the lip synch by the editing operation.

According to the operation of the video editing PC 300 as described above, the editing operation can be performed in a state where the video and the audio are synchronized by the management data D3 in the video timeline 80, and this facilitates the video editing process.

### 3. Summary

As described above, in the present embodiment, the information support terminal 200 as an example of an electronic device for managing a video with a scenario including a plurality of cuts as an example a plurality of sections. The information support terminal 200 includes a display 240 that displays information, a user interface 230 as an example of an input interface that inputs a user operation, and a controller 210 that controls the display 240 in accordance with the user operation input from the user interface 230. The controller 210 causes the display 240 to display a setting screen (see FIGS. 6 and 7) for the audio source data associated with the scenario to acquire cut allocation data D1, which is an example of audio setting information, in accordance with the user operation from the user interface 230, the audio setting information associating, as an example of a synchronous section, the cut of the lip sync in a plurality of cuts with audio indicated by the audio source data, such as the music (S10 to S17). Based on the acquired cut allocation data D1, the controller 210 generates management data D3 on a plurality of videos associated with the plurality of cuts, the management data D3 managing a positional relationship in which video information is arranged along a time series of the music on the video editing screen (FIG. 16) as an example of an editing screen for editing the plurality of videos. the video information indicating respective videos in the plurality of videos (S63 to S64).

By the information support terminal 200 described above, the management data D3 managing the positional relationship in which the video information is arranged along the time series in the music on the video editing screen facilitates for the user performing the video editing process in accordance with the music for the shooting result of the video for each cut. Furthermore, in the present system 10, by the management data D3 such as the video timeline 80, the processing efficiency for the process in the video editing PC 300 can be improved, for example.

In the information support terminal 200 according to the present embodiment, the controller 210 sets the music range, as a time range within the music of the audio source data, the cut of the lip synch among the plurality of cuts (an example of the synchronous section associated with the audio) in the cut allocation data D1, in accordance with the user operation from the user interface 230, the music range being associated with a video of the cut of the lip sync in the scenario (S12 to S14). The controller 210 generates the management data D3 based on the cut allocation data D1 (see FIG. 8) set for each cut in the plurality of cuts, to bring the video information of the cut of the lip synch to be arranged in the time range set in the time series of the audio source data on the video editing screen (S63, S83, S86). Therefore, for example, the cut of the lip synch is arranged in the corresponding music range in the time series of the music indicated by the audio source data, and such an arrangement can facilitate the video editing in accordance with the music.

In the information support terminal 200 according to the present embodiment, the controller 210 further sets the cut of the B-roll (an example of an asynchronous section not associated with audio) among the plurality of cuts in the cut allocation data D1, in accordance with the user operation from the user interface 230 (S12, S15). The controller 210 generates the management data D3 to identify the cut of the lip synch and the cut of the B-roll among the plurality of cuts based on the cut allocation data D1 (see FIG. 8) set for each cut (S63, S82 to S84, S86). Therefore, for example, each cut can be arranged in the video timeline 80 according to the setting of the lip synch and the B-roll, and this further facilitates the video editing (see FIGS. 16 to 18).

In the present embodiment, the management data D3 manages the video timeline 80 as an example of a timeline in which the video clip 85, the audio clip 86b (each as an example of video information), and the like are arranged chronologically on the video editing screen (see FIGS. 18, 19, and 21). The controller 210 generates the management data D3 to bring the video clip 85 of the cut of the lip synch and the like to be arranged in the video timeline 80 in accordance with the set music range in the time series of the audio source data (S63, S82 to S83, S86). Therefore, for example, in the video timeline 80 for the lip synch, the audio clip 86a of the music and the video clip 85 of the cut of the lip synch can be arranged to be synchronized with each other according to the music range set to the cut.

The information support terminal 200 according to the present embodiment further includes a speaker 270 as an example of an audio output interface that performs audio output. The controller 210 controls the video shooting for each cut based on the cut allocation data D1 (S21 to S27) to cause the speaker 270 to output the audio for playing the music in accordance with the set music range in the video shooting of the cut of the lip synch (S25, S42 to S45). Therefore, for the cut of the lip synch, it is possible to shoot a video of the cut with the audio in the set music range being played. This also facilitates shooting of a video in accordance with the music, and accordingly facilitates the video editing in accordance with the music based on the shot video, for example.

In the information support terminal 200 according to the present embodiment, the controller 210 sets the timer period as an example of a predetermined period in accordance with an additional user operation from the user interface 230 (S44). The controller 210 controls the speaker 270 to perform the audio output before the music range in the music set to the cut in accordance with the timer period in the video shooting of the lip synch (see S45, FIGS. 14A to 14C). Therefore, for example, the timing of the video shooting of the cut can be easily adjusted, and this also facilitates shooting of the video in accordance with the music.

In the information support terminal 200 according to the present embodiment, the controller 210 receives, from the user interface 230, the user operation to associate one or more cuts of a plurality of cuts with the time range in the music, and acquires cut allocation data D1 (S13 to S14,S17). Therefore, for example, one or more cuts of the lip synch can be set to be associated with mutually overlapping ranges of the time range in the music.

In the present embodiment, a video management method for managing a video with a scenario including a plurality of sections such as cuts is provided. In the present method, the controller 210 of the information support terminal 200 as an example of an electronic device causes the display 240 to display the setting screen (see FIGS. 6 and 7) For the audio source data associated with the scenario to acquire cut allocation data D1 as an example of audio setting information in accordance with a user operation input from the user interface 230, the audio setting information associating a cut in the plurality of cuts with the music as an example of the audio indicated by the audio source data (S10 to S17). Based on the acquired cut allocation data D1, the controller 210 generates the management data D3 on a plurality of videos associated with the plurality of cuts, the management data D3 managing a positional relationship in which video information indicating each video is arranged along a time series in the music on the video editing screen (FIG. 16) as an example of an editing screen for editing the plurality of videos (S63 to S64).

In the present embodiment, the storage 221 as an example of a non-transitory computer readable medium storing a program for causing the controller 210 to execute the video management method described above is provided. Such a video management method facilitates editing of a video with the scenario including the plurality of cuts in association with the audio source data. Various types of information management for each cut as described above are not necessarily performed per cut, and may be performed for a set of cuts including a plurality of cuts.

In the present embodiment, similarly to the configuration of the information support terminal 200 illustrated in FIG. 3, for example, the video editing PC 300 as an example of a video editing device includes a display that displays a video editing screen (see FIG. 23) as an example of an editing screen for editing a plurality of videos, a communication interface as an example of a data input interface that inputs data, a user interface that receives a user operation, and a controller that controls the display based on the data input from the data input interface. The controller acquires, from the data input interface, video data indicating a video, audio source data associated with a scenario including a plurality of sections such as cuts, and management data D3, the video being shot in association with each cut in the scenario, the management data D3 associating a cut of the lip sync as an example of a synchronous section in the plurality of cuts with the music as an example of audio indicated by the audio source data (S91). The management data D3 manages a positional relationship in which video information indicating respective videos associated with the plurality of cuts is arranged on the video editing screen along a time series of the music (see FIGS. 21 and 23). Based on the management data D3, the controller causes the display to display the video timeline 80 as an example of a timeline in which the video information of the cut of the lip synch (an example of the synchronous section associated with the audio) among the plurality of cuts is arranged on the video editing screen along the time series of the music (S92). The controller 210 receives, from the user interface, the user operation editing a video indicated by the video information on the video editing screen (S93).

According to the video editing PC 300 described above, for example, the video information for each cut and the time range in the music can be arranged in association with each other in the video timeline 80 of the video editing screen based on the management data D3, and the user can easily perform the video editing process in accordance with the music. Furthermore, for example, the processing efficiency for the process in the video editing PC 300 can be improved.

### Other Embodiments

As described above, the first embodiment is described as an example of the technology disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment.

In the first embodiment described above, the information support terminal 200 is described as an example of an electronic device different from the imaging apparatus, but the present disclosure is not limited thereto. The electronic device according to the present embodiment may be integrated with an imaging apparatus that executes video shooting. In the present embodiment, for example, the digital camera 100 may have various functions similar to those of the information support terminal 200 described above. Similarly to the first embodiment, the digital camera 100 can also provide the information support by the scenario creation function, the export function, and the like to the user.

In the above embodiments, the cut selection screen including the cut list 30 is exemplified, but the selection screen of the present disclosure is not limited thereto. The selection screen according to the present embodiment may not include the cut list 30, and may include a plurality of cuts in a display mode different from the cut icon 3. In addition, the selection screen according to the present embodiment may be a dialog display, or may be superimposed and displayed on various display screens. In the present embodiment, the cut list 30 may be an example of the selection screen. In the present embodiment, the selection screen of the information support terminal 200 may identify and display whether or not the video shooting is completed for each cut in various display modes other than the above-described example.

In the above embodiments, three types of examples in which the rating information is “OK”, “KEEP”, and “BAD” have been described, but the rating information is not particularly limited thereto. In the present embodiment, the rating information may be three types of rating different from the above, and is not particularly limited to three types, and may be two types or four or more types. Furthermore, in the present embodiment, the rating information may be a score of a continuous value. The electronic device according to the present embodiment may receive a user input of such various types of rating information and manage video shooting for each cut. For example, the identification display can be performed by appropriately providing a criterion as to whether or not the video shooting of the cut is completed. In addition, the information support terminal 200 according to the present embodiment may set a priority order in the management data D3 so as to reflect such various ratings.

In the above embodiments, an example is described in which the management data D3 includes the video folder 70 and the video timeline 80. In the present embodiment, the management data may be generated omitting the video folder 70, for example. In addition, in the above embodiments, an example in which the management data D3 is written in the XML language is described. In the present embodiment, the management data D3 is not limited to be written in the XML language, and may be written in various markup languages or data description languages that can be supported by the editing software used in the video editing process. The management data D3 may be various kinds of metadata for managing videos of various cuts.

In the above embodiments, the information support terminal 200 as an example of an electronic device and the video editing PC 300 as an example of an external device are described. In the present embodiment, the electronic device may be the video editing PC 300, and the video editing PC 300 may have various functions of the information support terminal 200 described above. In the present embodiment, the editing screen may be displayed not only on the external device but also on the electronic device. Furthermore, in a case where an external display device is used in the video editing PC 300, the external device according to the present embodiment may include such a display device.

In the above embodiments, the digital camera 100 including the optical system 110 and the lens driver 112 is exemplified. The imaging apparatus according to the present embodiment may not particularly include the optical system 110, the lens driver 112, and the like, and may be, for example, an interchangeable lens type camera.

Furthermore, in the above embodiments, the digital camera is described as an example of the imaging apparatus, but the present disclosure is not limited thereto. The imaging apparatus of the present disclosure has only to be an electronic device having an image shooting function (e.g., a video camera, a smartphone, a tablet terminal, or the like). Furthermore, the electronic device of the present disclosure does not particularly need to have an image shooting function, and may be various electronic devices.

### ASPECT EXAMPLES

Hereinafter, various aspects of the present disclosure will be exemplified.

A first aspect according to the present disclosure is an electronic device for managing a video with a scenario including a plurality of sections. The electronic device includes: a display that displays information; an input interface that inputs a user operation; and a controller that controls the display in accordance with the user operation input from the input interface. The controller causes the display to display a setting screen for audio source data associated with the scenario to acquire audio setting information in accordance with the user operation from the input interface, the audio setting information associating a synchronous section in the plurality of sections with audio indicated by the audio source data. The controller generates management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos.

A second aspect is the electronic device according to the first aspect, wherein the controller sets a time range in the audio of the audio source data to the synchronous section associated with the audio among the plurality of sections in the audio setting information, in accordance with the user operation from the input interface, the time range being associated with a video of the synchronous section. The controller generates the management data to bring the video information of the synchronous section associated with the audio to be arranged on the editing screen in the set time range in the time series of the audio source data, based on the audio setting information set for each section in the plurality of sections.

A third aspect is the electronic device according to the second aspect, wherein the controller further sets an asynchronous section not associated with the audio among the plurality of sections to the audio setting information, in accordance with the user operation from the input interface. The controller generates the management data to identify the synchronous section associated with the audio and the asynchronous section not associated with the audio among the plurality of sections based on the audio setting information set for each section.

A fourth aspect is the electronic device according to the second or third aspect, wherein the management data manages a timeline in which the video information is arranged chronologically on the editing screen. The controller generates the management data to bring the video information of the synchronous section associated with the audio among the plurality of sections to be arranged in the timeline in accordance with the set time range in the time series of the audio source data.

A fifth aspect is the electronic device according to any of the second to fourth aspects, further including an audio output interface that performs audio output. The controller controls video shooting for each section in the plurality of sections based on the audio setting information to cause the audio output interface to output the audio in accordance with the set time range in the video shooting of the synchronous section associated with the audio.

A sixth aspect is the electronic device according to the fifth aspect, wherein the controller sets a predetermined period in accordance with an additional user operation from the input interface. The controller controls the audio output interface to perform the audio output before the set time range in the audio of the audio source data in accordance with the predetermined period in the video shooting of the synchronous section associated with the audio.

A seventh aspect is the electronic device according to any of the first to sixth aspects, wherein the controller receives, from the input interface, the user operation to associate one or more sections of the plurality of sections with the time range in the audio, and acquires the audio setting information.

A eighth aspect is a video management method for managing a video with a scenario including a plurality of sections. The video management method includes, by a controller of an electronic device: causing a display to display a setting screen for audio source data associated with the scenario to acquire audio setting information in accordance with a user operation input from an input interface, the audio setting information associating a section in the plurality of sections with audio indicated by the audio source data; and generating management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos, the video information indicating respective videos in the plurality of videos.

A ninth aspect is a non-transitory computer readable medium storing a program for causing the controller to execute the video management method according to the eighth aspect.

A tenth aspect is a video editing device including: a display that displays an editing screen for editing a plurality of videos; a data input interface that inputs data; a user interface that receives a user operation; and a controller that controls the display based on the data input from the data input interface. The controller acquires, from the data input interface, video data indicating a video, audio source data associated with a scenario including a plurality of sections, and management data, the video being shot in association with each section in the scenario, the management data associating a synchronous section in the plurality of sections with audio indicated by the audio source data. The management data manages a positional relationship in which video information is to be arranged on the editing screen along a time series of the audio of the audio source data, the video information indicating respective videos associated with the plurality of sections. The controller causes the display to display a timeline in which the video information of the synchronous section associated with the audio among the plurality of sections is arranged on the editing screen along the time series of the audio source data based on the management data, and receives, from the user interface, the user operation editing a video indicated by the video information on the editing screen.

As described above, the embodiments have been described as an example of the technology in the present disclosure. For this purpose, the accompanying drawings and the detailed description have been provided. Accordingly, some of the components described in the accompanying drawings and the detailed description may include not only essential components for solving the problem but also components which are not essential for solving the problem in order to describe the above technology.

The present disclosure is applicable to shooting and editing videos including multiple sections such as cuts in association with a music track or other audio.

1. An electronic device for managing a video with a scenario including a plurality of sections, the electronic device comprising:
a display that displays information;
an input interface that inputs a user operation; and
a controller that controls the display in accordance with the user operation input from the input interface,
wherein the controller causes the display to display a setting screen for audio source data associated with the scenario to acquire audio setting information in accordance with the user operation from the input interface, the audio setting information associating a synchronous section in the plurality of sections with audio indicated by the audio source data, and
generates management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos, the video information indicating respective videos in the plurality of videos.

2. The electronic device according to claim 1,
wherein the controller sets a time range in the audio of the audio source data to the synchronous section associated with the audio among the plurality of sections in the audio setting information, in accordance with the user operation from the input interface, the time range being associated with a video of the synchronous section, and
generates the management data to bring the video information of the synchronous section associated with the audio to be arranged on the editing screen in the set time range in the time series of the audio source data, based on the audio setting information set for each section in the plurality of sections.

3. The electronic device according to claim 2,
wherein the controller further sets an asynchronous section not associated with the audio among the plurality of sections to the audio setting information, in accordance with the user operation from the input interface, and
generates the management data to identify the synchronous section associated with the audio and the asynchronous section not associated with the audio among the plurality of sections based on the audio setting information set for each section.

4. The electronic device according to claim 2,
wherein the management data manages a timeline in which the video information is arranged chronologically on the editing screen, and
the controller generates the management data to bring the video information of the synchronous section associated with the audio among the plurality of sections to be arranged in the timeline in accordance with the set time range in the time series of the audio source data.

5. The electronic device according to claim 2, further comprising an audio output interface that performs audio output,
wherein the controller controls video shooting for each section in the plurality of sections based on the audio setting information to cause the audio output interface to output the audio in accordance with the set time range in the video shooting of the synchronous section associated with the audio.

6. The electronic device according to claim 5,
wherein the controller sets a predetermined period in accordance with an additional user operation from the input interface, and
controls the audio output interface to perform the audio output before the set time range in the audio of the audio source data in accordance with the predetermined period in the video shooting of the synchronous section associated with the audio.

7. The electronic device according to claim 1, wherein the controller receives, from the input interface, the user operation to associate one or more sections of the plurality of sections with the time range in the audio, and acquires the audio setting information.

8. A video management method for managing a video with a scenario including a plurality of sections, the video management method comprising, by a controller of an electronic device:
causing a display to display a setting screen for audio source data associated with the scenario to acquire audio setting information in accordance with a user operation input from an input interface, the audio setting information associating a section in the plurality of sections with audio indicated by the audio source data; and
generating management data on a plurality of videos based on the acquired audio setting information, the plurality of videos being associated with the plurality of sections, the management data managing a positional relationship in which video information is to be arranged along a time series of the audio of the audio source data on an editing screen for editing the plurality of videos, the video information indicating respective videos in the plurality of videos.

9. A non-transitory computer readable medium storing a program for causing the controller to execute the video management method according to claim 8.

10. A video editing device comprising:
a display that displays an editing screen for editing a plurality of videos;
a data input interface that inputs data;
a user interface that receives a user operation; and
a controller that controls the display based on the data input from the data input interface,
wherein the controller acquires, from the data input interface, video data indicating a video, audio source data associated with a scenario including a plurality of sections, and management data, the video being shot in association with each section in the scenario, the management data associating a synchronous section in the plurality of sections with audio indicated by the audio source data,
the management data manages a positional relationship in which video information is to be arranged on the editing screen along a time series of the audio of the audio source data, the video information indicating respective videos associated with the plurality of sections, and
the controller causes the display to display a timeline in which the video information of the synchronous section associated with the audio among the plurality of sections is arranged on the editing screen along the time series of the audio source data based on the management data, and
receives, from the user interface, the user operation editing a video indicated by the video information on the editing screen.
